(19) United States
(12) Patent Application Publication
(10) Pub. No.: US 2017/0087571 A1
(43) Pub. Date: Mar. 30, 2017

(54) Apparatus, Systems And Methods For Applying Fluidized Materials

(71) Applicant: RBW Enterprises, Inc., Newnan, GA (US)

(72) Inventors: Robert B Watkin, Peachtree City, GA (US); Amanda Vogel, Grantville, GA (US); Trey Westerhoff, Moreland, GA (US)

(21) Appl. No.: 15/270,492

(22) Filed: Sep. 20, 2016

Related U.S. Application Data
(60) Provisional application No. 62/233,378, filed on Sep. 27, 2015.

(51) Int. Cl. B05B 3/18; B05B 15/04; B05B 15/10; B05C 1/08

(52) U.S. Cl. CPC B05B 3/18; B05C 1/0821; B05B 15/04; B05B 15/10

(57) ABSTRACT

Apparatus, systems and methods for applying fluidized materials to surfaces are encompassed by the present disclosure. The apparatus and systems can include a movable carriage supporting an applicator mount assembly that receives a fluidized material applicator for applying a fluidized material to a surface. The applicator system can move a fluidized material applicator in a reciprocating cycle along a horizontal path and allow for the pivotal rotation of the fluidized material applicator about a vertical axis while the applicator is applying a fluidized material to a surface. An accessory applicator system also is provided that can be used in conjunction with or separate and apart from the applicator system and can be used to apply a fluidized material to a surface via a roller, brush or similar non-spray applicator. The apparatus and systems encompassed by the present disclosure can be operated remotely away from the surface to which a fluidized material is applied.

### RELATED APPLICATION

This application claims the benefit of priority to U.S. Provisional Application No. 62/233,378, filed Sep. 27, 2015. The provisional application identified above is hereby incorporated by reference in its entirety herein to provide continuity of disclosure.

### TECHNICAL FIELD

The present disclosure is directed generally to applicator systems and methods for application of fluidized materials and, more specifically, to apparatus, systems and methods for application of fluidized materials through other than manual means.

### BACKGROUND

Generally, storage tanks, buildings and other structures are painted or coated by hand using conventional painting apparatus, such as spray guns, rollers and brushes. Typically, painting or coating of a storage tank or building requires at least one person to be elevated above ground level in order for the person to operate the painting apparatus at the point of application of the paint to the structure to be painted. Elevating personnel with the use of aerial lifts, ladders or scaffolding requires proper equipment, training and oversight to ensure that applicable regulations and safety procedures are followed. In some cases, multiple personnel must be involved to assist in the operation of equipment and compliance with regulatory requirements. Accordingly, elevating personnel entails added time, equipment, cost and safety concerns. In addition to elevated surfaces, other surfaces, such as floors, can create challenges for application of liquid coatings. Furthermore, overspray from spray nozzles is a major concern since atomized materials can be transferred by the wind and deposited on cars, equipment and other structures.

Consequently, there is a need for apparatus, systems and methods for applying fluidized materials to surfaces and structures that lessen some of the challenges posed by some structures, surfaces, and systems.

### SUMMARY

The present disclosure encompasses apparatus, systems and methods for applying a fluidized material to a work surface. The present disclosure encompasses a system for use in applying a fluidized material to a surface, wherein the system comprises a carriage, an applicator mount assembly movably mounted to the carriage, wherein the carriage comprises a support body and an actuator mounted to the support body, wherein the applicator mount assembly is operably connected to the actuator, wherein the applicator mount assembly is reciprocatingly movable by the actuator along a path, wherein the applicator mount assembly comprises a support bracket and an applicator mount pivotally mounted to the support bracket, and wherein the applicator mount is configured to receive a fluidized material applicator. In another aspect, the actuator can comprise a cable cylinder comprising a reciprocating cable operably connected to the applicator mount assembly, wherein the applicator mount assembly is reciprocatingly movable along the path by movement of the reciprocating cable. In yet another aspect, the system further can comprise a first striker mounted proximal to a first end of the carriage and a second striker mounted proximal to a second end of the carriage, wherein the first striker and the second striker cooperate with the applicator mount to pivot the fluidized material applicator. In a further aspect, the system further can comprise a hoist system comprising a hoist motor operably connected to a hoist drum, and a hoist line operably connected to the hoist drum, and wherein the carriage is suspended from the hoist line. In still another aspect, the system further can comprise a hoist support supporting the hoist system, wherein the hoist support comprises a trolley and a plurality of castors mounted on the trolley. In yet another aspect, the carriage can be suspended from a first hoist line and a second hoist line, wherein the first hoist line is connected to the support body proximal to a first end of the support body and the second hoist line is connected to the support body proximal to a second end of the support body. In another aspect, the carriage can be operably connected to a first stabilizer and a second stabilizer, wherein the first stabilizer is operably connected to the support body proximal to a first end of the support body and the second stabilizer is operably connected to the support body proximal to a second end of the support body. In one aspect, the system further can comprise a shroud assembly supported by the applicator mount assembly, wherein the shroud assembly comprises a shroud body defining a shroud chamber and a shroud opening, wherein the shroud opening is in fluid communication with the shroud chamber, a venturi section in fluid communication with the shroud chamber, an exhaust port in fluid communication with the venturi section, an exhaust receptacle in fluid communication with the exhaust port, and wherein at least a portion of the fluidized material applicator is disposed within the shroud chamber. In a further aspect, the fluidized material applicator can comprise a trigger, and the applicator mount can comprise a trigger actuator operably connected to the trigger. In still another aspect, the system further can comprise a control system operably connected to the actuator. In a further aspect, the control system can comprise a pneumatic control assembly configured to receive a compressed gas. In another aspect, the carriage can be suspended from a telescoping support arm. In still a further aspect, the system further can comprise a traction hoist connected to the carriage. In yet another aspect, the applicator mount assembly can further comprise an accessory support arm pivotally mounted to the support bracket, an accessory applicator actuator mounted on the accessory support arm, an accessory applicator arm mounted on the accessory support arm, wherein the applicator mount is connected to the accessory applicator arm, wherein the fluidized material applicator is operably connected to the accessory applicator actuator, and wherein the fluidized material applicator is reciprocatingly movable by the accessory applicator actuator along a second path. In another aspect, the fluidized material applicator can be a roller.

The present disclosure also encompasses a system for applying a fluidized material to a surface, the system comprising a carriage comprising a support body and a cable cylinder mounted to the support body, wherein the cable cylinder comprises a reciprocating cable, an applicator mount assembly mounted on the support body and operably connected to the reciprocating cable, wherein the applicator mount assembly comprises a support bracket and an applicator mount mounted to the support bracket, wherein the applicator mount is configured to receive a fluidized material applicator, wherein the applicator mount assembly is reciprocatingly movable along a path by cooperation of the applicator mount assembly with the reciprocating cable, and, a first striker mounted to the carriage and a second striker mounted to the carriage, wherein the first striker and the second striker are aligned to cooperate with the applicator mount assembly to pivot the fluidized material applicator. In one aspect, the system further can comprise a hoist line operably connected to the carriage, wherein the carriage is movable by cooperation with the hoist line. In another aspect, the system further can comprise a hoist system comprising a hoist motor operably connected to a hoist drum, wherein the hoist line is operably connected to the hoist drum, and wherein the carriage is suspended from the hoist line. In a further aspect, the system further can comprise a hoist support supporting the hoist system, wherein the hoist support comprises a trolley and a plurality of castors mounted on the trolley. In still another aspect, the system further can comprise a stabilizer mounted to the trolley, wherein the stabilizer is operably connected to the carriage to stabilize the carriage. In another aspect, the fluidized material applicator can comprise a trigger, and the applicator mount can comprise a trigger actuator operably connected to the trigger. In yet another aspect, the system further can comprise a shroud assembly supported by the applicator mount assembly, wherein the shroud assembly comprises a shroud body defining a shroud chamber and a shroud opening, wherein the shroud opening is in fluid communication with the shroud chamber, a venturi section in fluid communication with the shroud chamber, an exhaust port in fluid communication with the venturi section, an exhaust receptacle in fluid communication with the exhaust port, and wherein at least a portion of the fluidized material applicator is disposed within the shroud chamber. In still another aspect, the system further can comprise a control system operably connected to the cable cylinder. In a further aspect, the control system can comprise a pneumatic control assembly configured to receive a compressed gas. In another aspect, the carriage can be suspended from a telescoping support arm. In yet another aspect, the system further can comprise a traction hoist connected to the carriage. In a further aspect, the applicator mount assembly further can comprise an accessory support arm pivotally mounted to the support bracket, an accessory cable cylinder mounted on the accessory support arm, wherein the accessory cable cylinder comprises an accessory reciprocating cable, an accessory applicator arm mounted on the accessory support arm, wherein the applicator mount is attached to the accessory applicator arm, wherein the fluidized material applicator is operably connected to the accessory reciprocating cable, and wherein the accessory applicator is reciprocatingly movable by the accessory reciprocating cable along a second path. In another aspect, the fluidized material applicator can be a roller.

The present disclosure also encompasses an applicator system for use in applying a fluidized material to a surface, wherein the system comprises a carriage and an applicator mount assembly movably mounted to the carriage, and wherein the applicator mount assembly can receive a fluidized material applicator for applying a fluidized material to a surface. In another aspect, the apparatus can further comprise a positioning assembly for positioning the applicator mount assembly at different positions during an application cycle. In yet another aspect, the positioning system can comprise a first striker and a second striker wherein the first and the second strikers engage and realign the applicator mount during an application cycle. In a further aspect, the applicator mount assembly can further comprise an applicator mount for receiving and securing in proper alignment a fluidized material applicator for applying a fluidized material to a surface. In still a further aspect, the apparatus can further comprise a control assembly for the operational control during an application cycle of the application of a fluidized material to a surface. In yet another aspect, the control assembly can be pneumatically operated. In still a further aspect, the applicator apparatus can provide for the robotic application of a fluidized material to a surface along one axis of movement. In yet another aspect, the applicator system can provide for the robotic application of a fluidized material to a surface along two axes of movement.

The present disclosure also encompasses an accessory applicator system that can be used in conjunction with the applicator system described herein or separately therefrom. The accessory applicator system can comprise an applicator mount assembly that can be mounted to the carriage of the applicator system or other support structure.

The applicator system further can comprise a support arm operably connected to the applicator mount assembly and a movable accessory applicator arm operably connected to the support arm, wherein the movable accessory applicator arm can receive a fluidized material applicator used to apply a fluidized material to a surface. The accessory applicator system further can comprise a cable cylinder supported by the support arm and operably connected to the movable accessory applicator arm. The accessory applicator system further can comprise a control assembly operably connected to the movable support arm for moving the movable support arm in a reciprocal movement. In one aspect, the control assembly can be pneumatically powered. In another aspect, the accessory applicator system can be movable about a plurality of axes. In another aspect, the accessory applicator system is movable about a first axis and a second axis. In a further aspect, the applicator operably connected to the movable accessory applicator arm is a roller.

The present disclosure also encompasses remote-controlled application systems for applying a fluidized material to a surface, wherein the system can comprise an applicator system and/or an accessory applicator system as described herein, wherein the applicator system and/or the accessory applicator system receives and operates a fluidized material applicator, a hoist system movably supporting the applicator system and/or the accessory applicator system, wherein the applicator system and/or the accessory applicator system is movable along a vertical path via the hoist system, and a support system supporting the hoist system, applicator system and/or the accessory applicator system, wherein the applicator system and/or the accessory applicator system is movable laterally via the support system.

The present disclosure also encompasses methods of applying a fluidized material to a surface wherein the method includes the steps of moving an applicator using the applicator system and/or the accessory applicator system and/or the systems described herein.

These and other aspects of the present disclosure are set forth in greater detail below and in the drawings for which a brief description is provided as follows.

### BRIEF DESCRIPTION OF THE DRAWINGS

FIG. 1 is a schematic view of a portion of a remote-controlled application system for applying fluidized material to a surface encompassing aspects of the present disclosure in use on a storage tank that is partially shown.

FIG. 2 is a perspective view delineated by line AA in FIG. 1 of a portion of a tension load box encompassing aspects of the present disclosure.

FIG. 3 is a perspective view delineated by line BB in FIG. 1 of a portion of the hoist system and hoist support encompassing aspects of the present disclosure.

FIG. 4 is a perspective view of a portion of the remote-controlled application system disclosed in FIG. 1 and encompassing aspects of the present disclosure.

FIG. 5 is a perspective view of the reciprocating cable and reciprocating cable mount disposed adjacent the support bracket of the applicator mount assembly, as well as portions of the cable cylinder, and fluidized material applicator disclosed in FIG. 4 and encompassing aspects of the present disclosure.

FIG. 6 is a perspective view of a portion of the carriage, the applicator mount assembly, and the fluidized material applicator of the applicator system shown in FIG. 4 with the hoist line and stabilizer removed.

FIG. 7 is a perspective view of a lower portion of the support bracket of the applicator mount assembly and the applicator mount connected thereto of the applicator system shown in FIG. 6 and encompassing aspects of the present disclosure.

FIG. 8 is a perspective view of a portion of the support bracket and applicator mount of the applicator mount assembly, the fluidized material applicator, the second striker mount, the second stabilizer guide, and the reciprocating cable of the applicator system shown in FIG. 6 and encompassing aspects of the present disclosure.

FIG. 9 is another perspective view of a portion of the support bracket and applicator mount of the applicator mount assembly, the fluidized material applicator, the second striker mount, the second stabilizer guide, and the reciprocating cable of the applicator system shown in FIG. 6 and encompassing aspects of the present disclosure.

FIG. 10 is a perspective view of a portion of the remote-controlled application system disclosed in FIG. 1 with the applicator mount assembly aligned adjacent the first end of the carriage and with the hoist lines and stabilizers removed and encompassing aspects of the present disclosure an applicator system encompassing aspects of the present disclosure.

FIG. 11 is a perspective view of the portion of the remote-controlled application system disclosed in FIG. 1 and shown in FIG. 10 with the applicator mount assembly aligned adjacent the second end of the carriage of the applicator system.

FIG. 12 is another perspective view of the portion of the remote-controlled application system disclosed in FIG. 1 and as shown in FIG. 10.

FIG. 13 is still another perspective view of the portion of the remote-controlled application system disclosed in FIG. 1 and as shown in FIG. 10.

FIG. 14 is yet another perspective view of the portion of the remote-controlled application system disclosed in FIG. 1 and as shown in FIG. 10.

FIG. 15 is a perspective view of a portion of the portion of the remote-controlled application system disclosed in FIG. 1 and as shown in FIG. 10 illustrating portions of the second striker mount, the second striker, the cable cylinder, the reciprocating cable, the applicator mount assembly, and the fluidized material applicator of the remote-controlled application system.

FIG. 16 is another perspective view of a portion of the portion of the remote-controlled application system disclosed in FIG. 1 and as shown in FIG. 10 illustrating portions of the second striker mount, the second striker, the cable cylinder, the reciprocating cable, the applicator mount assembly, and the fluidized material applicator of the remote-controlled application system.

FIG. 17 is still another perspective view of a portion of the portion of the remote-controlled application system disclosed in FIG. 1 and as shown in FIG. 10 illustrating portions of the second striker mount, the second striker, the cable cylinder, the reciprocating cable, the applicator mount assembly, and the fluidized material applicator of the remote-controlled application system.

FIG. 18 is yet another perspective view of a portion of the portion of the remote-controlled application system disclosed in FIG. 1 and as shown in FIG. 10 illustrating portions of the second striker mount, the second striker, the cable cylinder, the reciprocating cable, the applicator mount assembly, and the fluidized material applicator of the remote-controlled application system.

FIG. 19 is a front elevation view of a portion of the remote-controlled application system shown in FIG. 1 and illustrated in FIG. 10 with the single applicator mount assembly shown aligned both at the first end and at the second end of the carriage in position C and A, and the fluidized material applicator suspended in free space without the applicator mount assembly and aligned adjacent the mid-point of the carriage at position B so as to illustrate the relative positioning of the fluidized material applicator as the remote-controlled applicator system cycles through a reciprocating application cycle; and with the path of the applicator mount assembly and applicator mount illustrated by the dashed double-headed lines.

FIG. 20 is a schematic perspective view of the portion of the remote-controlled applicator system shown in FIG. 1 and illustrated in FIG. 14 with feed and return lines connecting the fluidized material applicator to a fluidized material receptacle assembly with a portion of the fluidized material receptacle assembly shown.

FIG. 21 is a schematic view of a portion of a pneumatic control system of a remote-controlled applicator system encompassed by the present disclosure with portions of the applicator mount, the fluidized material applicator, and the ends of the cable cylinder shown.

FIG. 22 is another schematic view of the portion of a pneumatic control system of a remote-controlled applicator system with portions of the applicator mount, the fluidized material applicator, and the ends of the cable cylinder shown in FIG. 21 and with a schematic view of a portion of the fluidized material receptacle assembly operably connected to the fluidized material applicator.

FIG. 23 is a front elevation view of a portion of another remote-controlled applicator system encompassing aspects of the present disclosure combined with a blast-cleaning machine.

FIG. 24 is a perspective view of the portion of the remote-controlled applicator system and the blast-cleaning machine shown in FIG. 23.

FIG. 25 is another perspective view of the portion of the remote-controlled applicator system and the blast-cleaning machine shown in FIG. 23.

FIG. 26 is a perspective view of an applicator system encompassing aspects of the present disclosure mounted on a blast-cleaning machine.

FIG. 27 is a side elevation view of the applicator system shown in FIG. 26 and illustrating two alternative extension positions E and F of the applicator system.

FIG. 28 is a perspective view of the applicator system and alternative extension positions as shown in FIG. 27.

FIG. 29 is a perspective view of yet another applicator system encompassing aspects of the present disclosure.

FIG. 30 is a perspective view of the applicator system as shown in FIG. 29.

FIG. 31 is yet another perspective view of the applicator system shown in FIG. 29.

FIG. 32 is a perspective view of a portion of an accessory applicator system that encompasses aspects of the present disclosure.

FIG. 33 is another perspective view of the portion of the accessory applicator system illustrated in FIG. 32.

FIG. 34 is yet another perspective view of the portion of the accessory applicator system illustrated in FIG. 32.

FIG. 35 is a side elevation view of the accessory applicator system illustrated in FIG. 32 with an alternative fluidized applicator mounted thereto and mounted on a hoist line and aligned adjacent to the sidewall of a storage tank in use adjacent a vertical wall, wherein the movements of the paths of the accessory applicator system are illustrated by double-headed lines GG and HH.

FIG. 36 is a schematic view of a portion of a pneumatic control system for use with the accessory applicator system illustrated in FIG. 32.

FIG. 37 is a perspective view of a portion of another remote-controlled application system encompassing aspects of the present disclosure.

FIG. 38 is a perspective view of the portion of the remote-controlled application system shown in FIG. 37 with the applicator mount pivotally rotated.

FIG. 39 is a perspective view of a shroud assembly and carriage cover operably connected to the portion of the remote-controlled application system shown in FIG. 38.

FIG. 40 is a side elevation view of the shroud assembly and carriage cover cooperating with the portion of the remote-controlled application system shown in FIG. 38.

FIG. 41 is another perspective view of the shroud assembly and carriage cover cooperating with the portion of the remote-controlled application system shown in FIG. 39, wherein the portion of the remote-controlled application system is mounted on two hoist lines and operably connected to two stabilizers and aligned adjacent a portion of a sidewall of a storage tank.

### DETAILED DESCRIPTION

The present disclosure encompasses apparatus, systems and methods that can be used to apply paint, coatings, sand, blasting particles, and/or other fluidized materials to a surface without manual application thereof by an operator. The present disclosure encompasses apparatus and systems that can be used to apply one or more fluidized materials to a surface. Such a fluidized material can include, but are not limited to, a paint, a primer, sand, an abrasive, water, an aqueous emulsion, an insulation material, a fire retardant, a surfactant, an emulsion, a coating and combinations thereof. Some of the embodiments of the apparatus and systems encompassed by the present disclosure can be used to apply paint, other coatings or other fluidized materials to an elevated surface, such as the wall of a building, storage tank, and/or reactor vessel, the hull of a ship and/or any other structure that would require the elevation of an operator who would apply the fluid-applied material manually, above either ground level, the floor and/or other stationary support surface. In other embodiments, apparatus and systems are provided for applying a fluidized material to a horizontal surface. In one aspect, the apparatus, systems and methods encompassed by the present disclosure can provide for the robotic movement of a stream of fluidized material in at least two directions. In another aspect, the apparatus, systems and methods encompassed by the present disclosure can provide for the robotic application of a stream of fluidized material along at least one axis of movement. In another aspect, the present disclosure encompasses apparatus, systems and methods that provide for the application of a stream of fluidized material along at least two axes of movement. In still another aspect, the present disclosure encompasses apparatus, systems and methods that provide for the application of a stream of fluidized material along at least three axes of movement. Wherever possible, the same reference numbers are used throughout the drawings to refer to the same or similar items.

As used herein, the singular forms of “a,” “an,” and “the” encompasses the plural form thereof unless otherwise indicated. As used herein, the phrase “at least one” includes all numbers of one and greater. The ranges used herein include all values that would fall within the stated range, including values falling intermediate of whole values. As used herein, the term “and/or” refers to one or all of the listed elements or a combination of any two or more of the listed elements.

As used herein, the term “reciprocatingly movable” refers to a state of being able to move back and forth alternately. As used herein, the term “mount” refers to positioned on or supported by, either directly or indirectly, a component. As used herein, the term “movably mounted” refers to the state of being mounted on or supported by a component while maintaining the state of being movable while remaining mounted. As used herein, the term “operably connected” refers to the direct or indirect connection of two or more parts whereby such connection allows for the two or more parts to cooperate in the performance of an intended function.

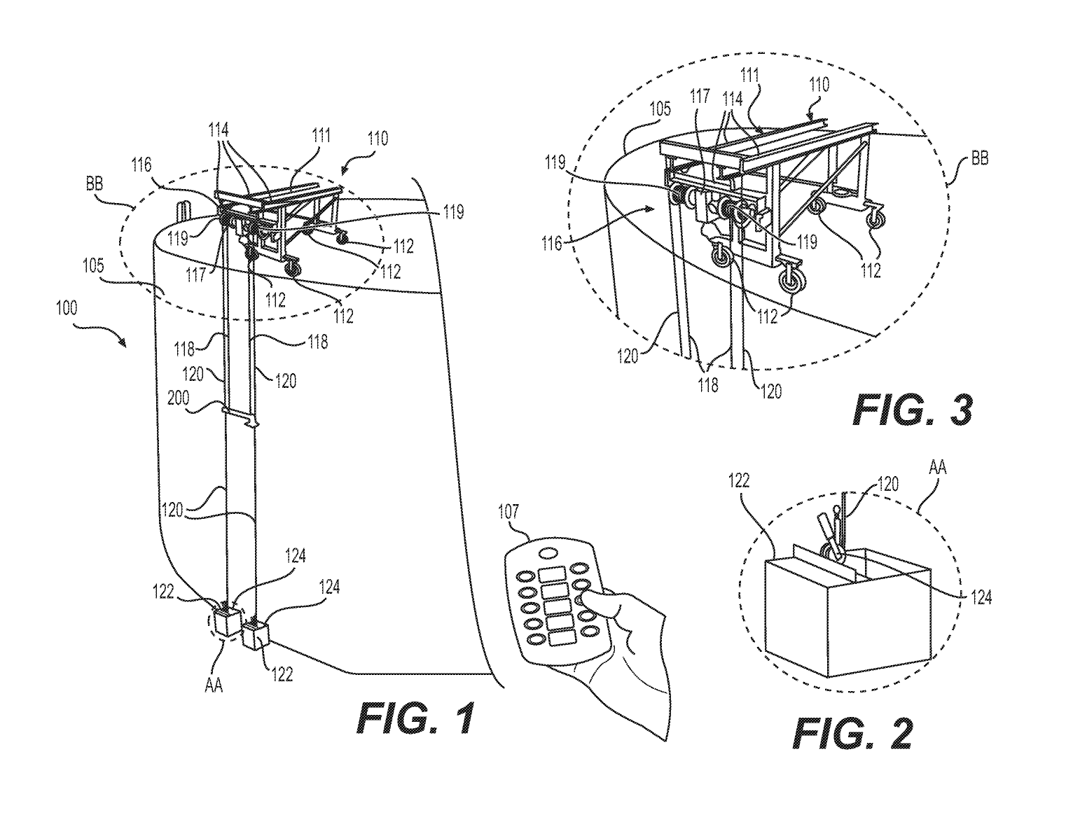

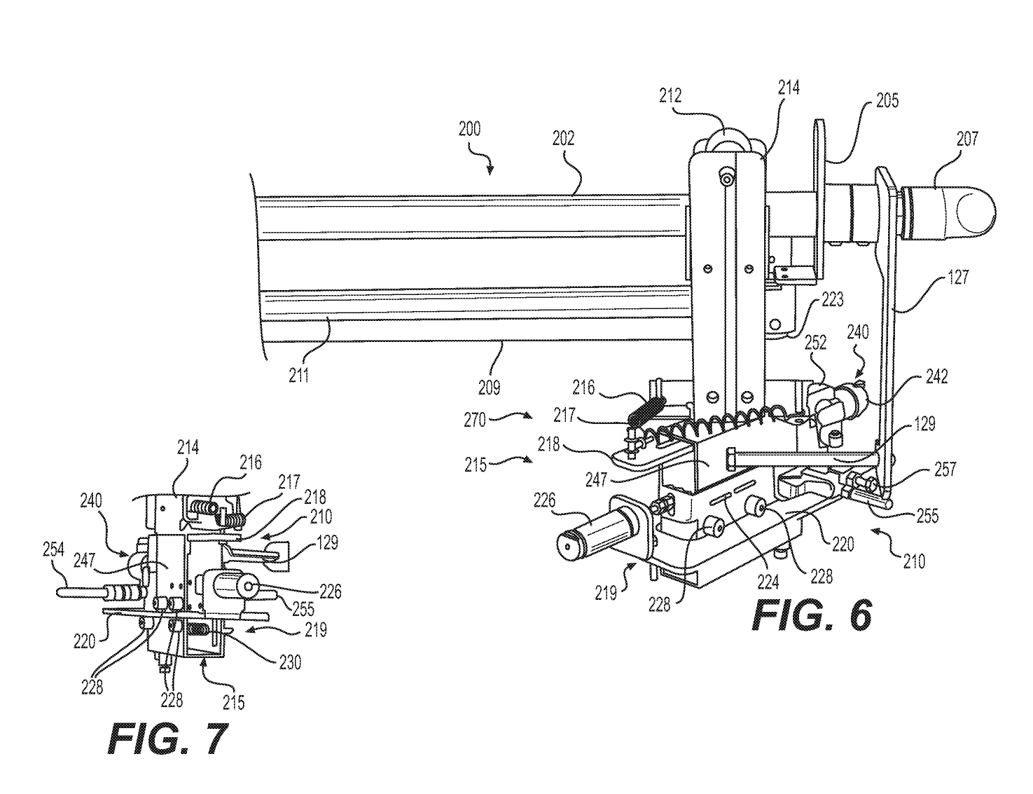

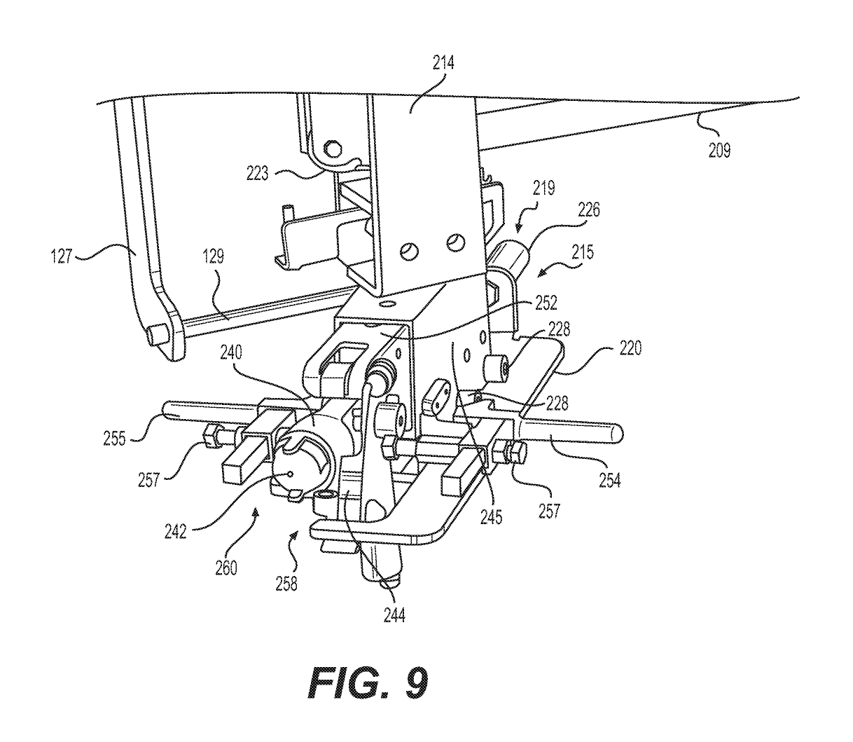

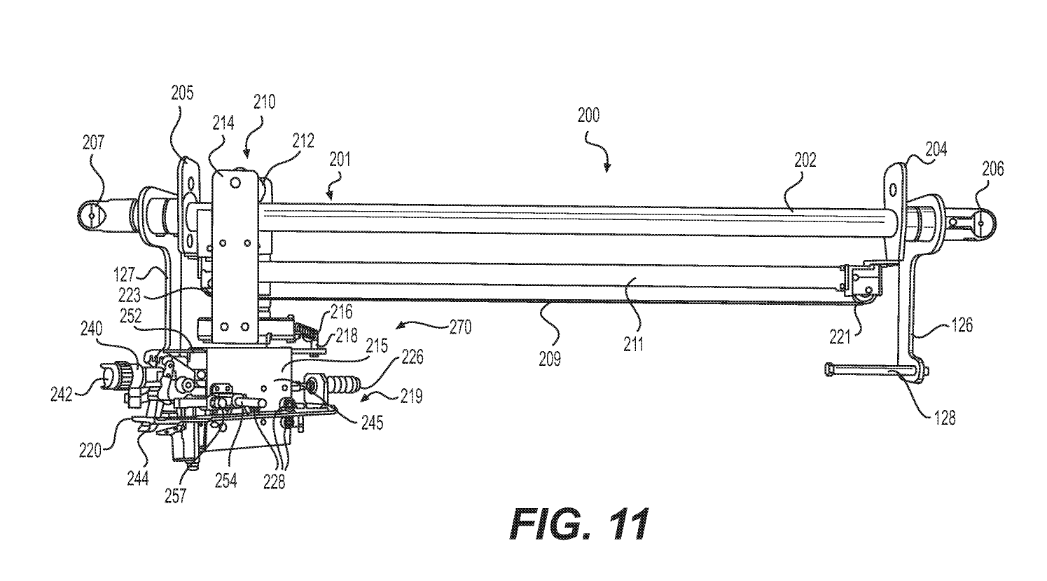

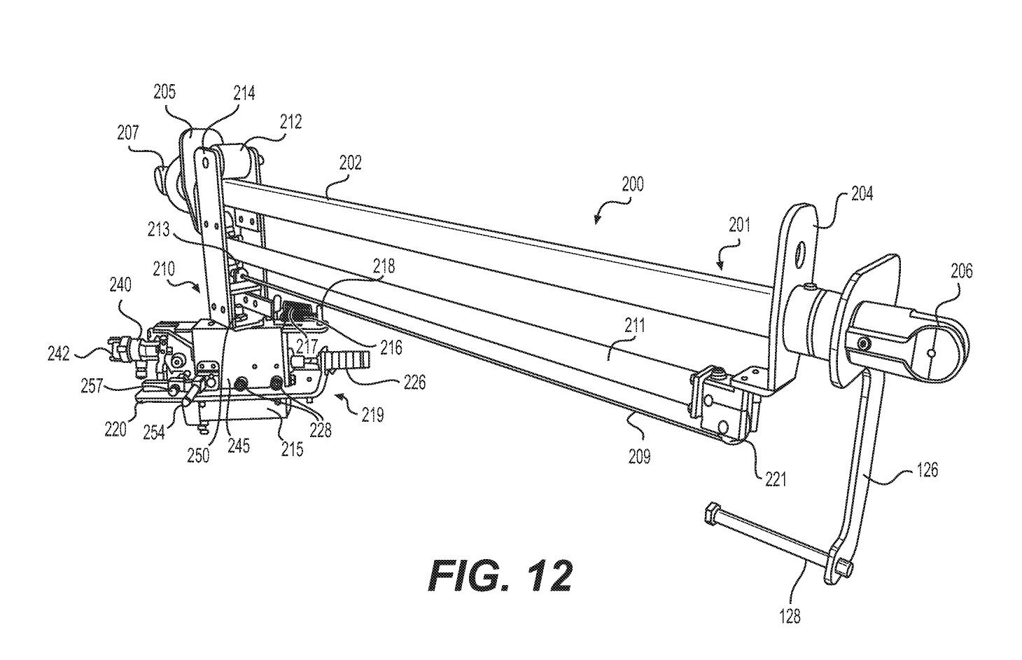

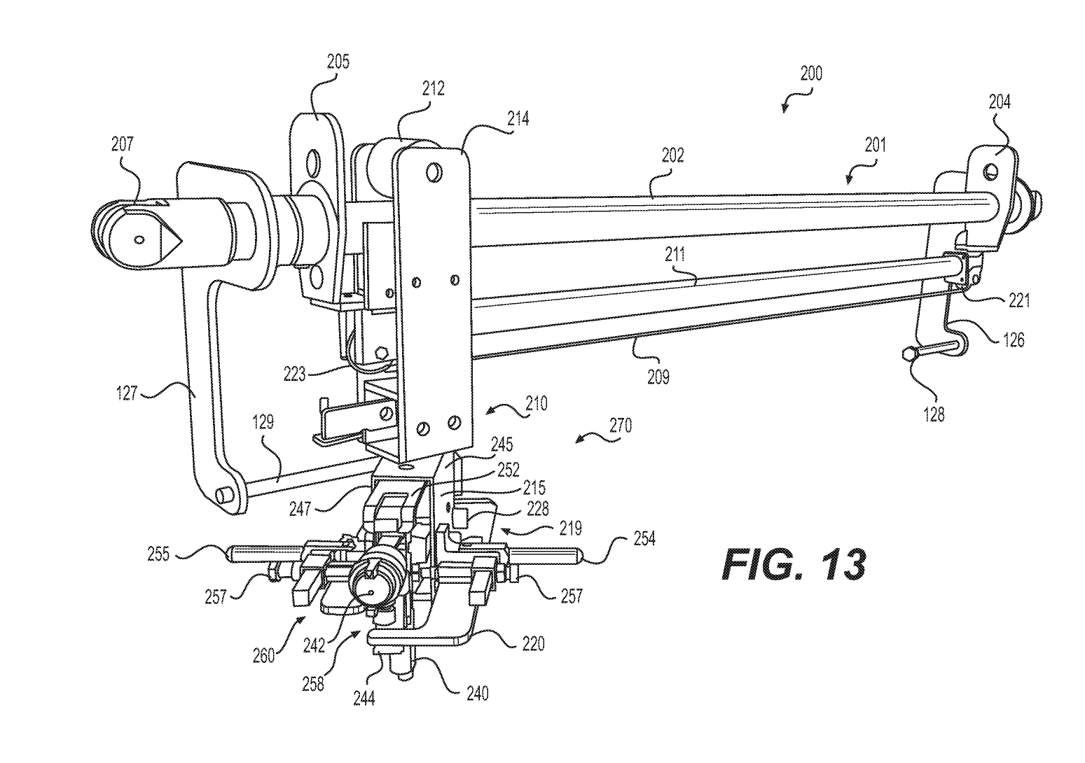

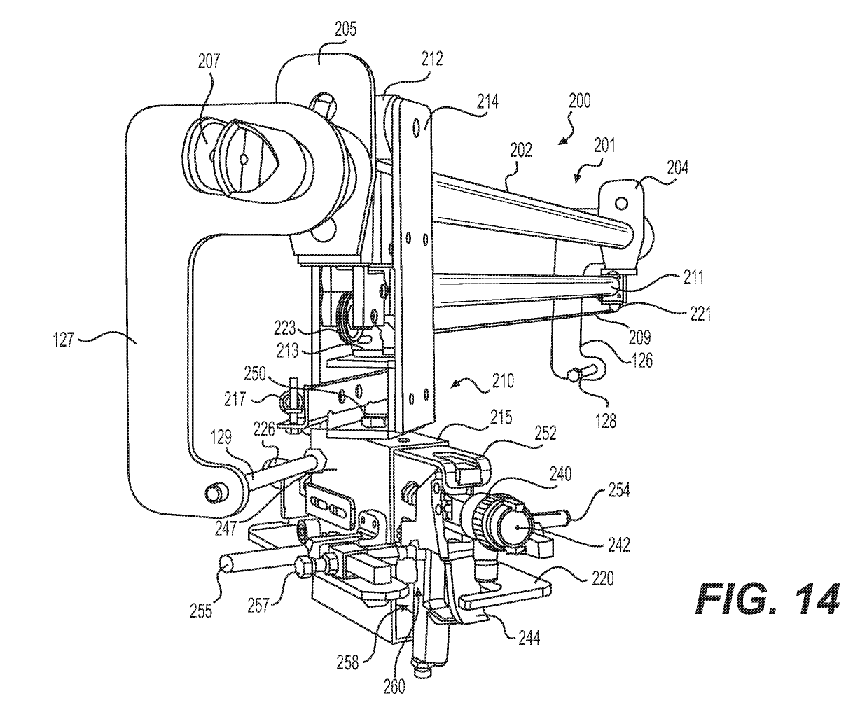

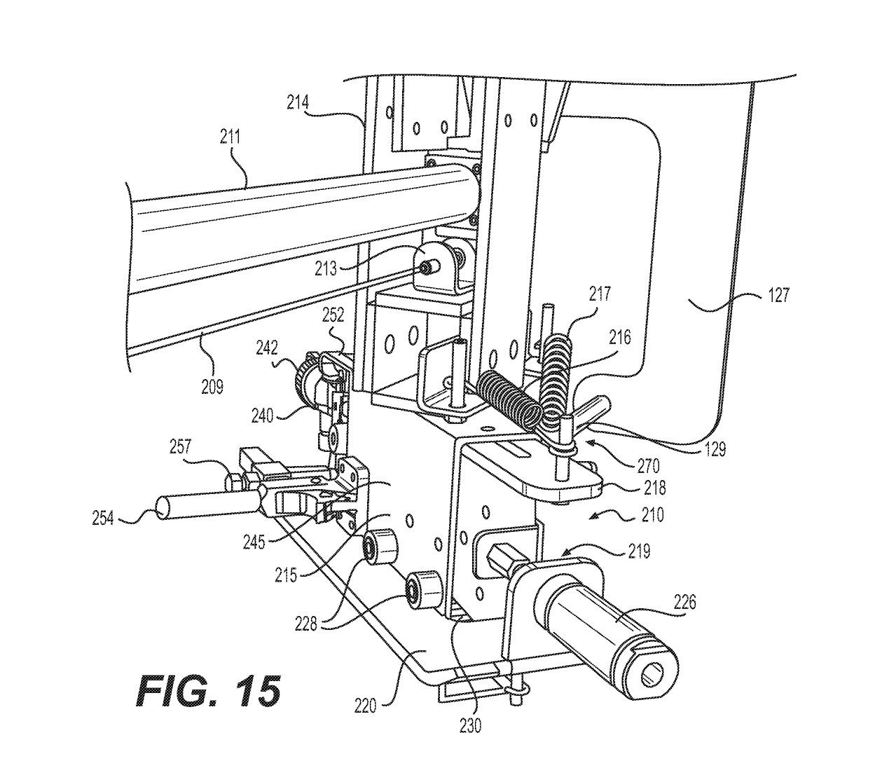

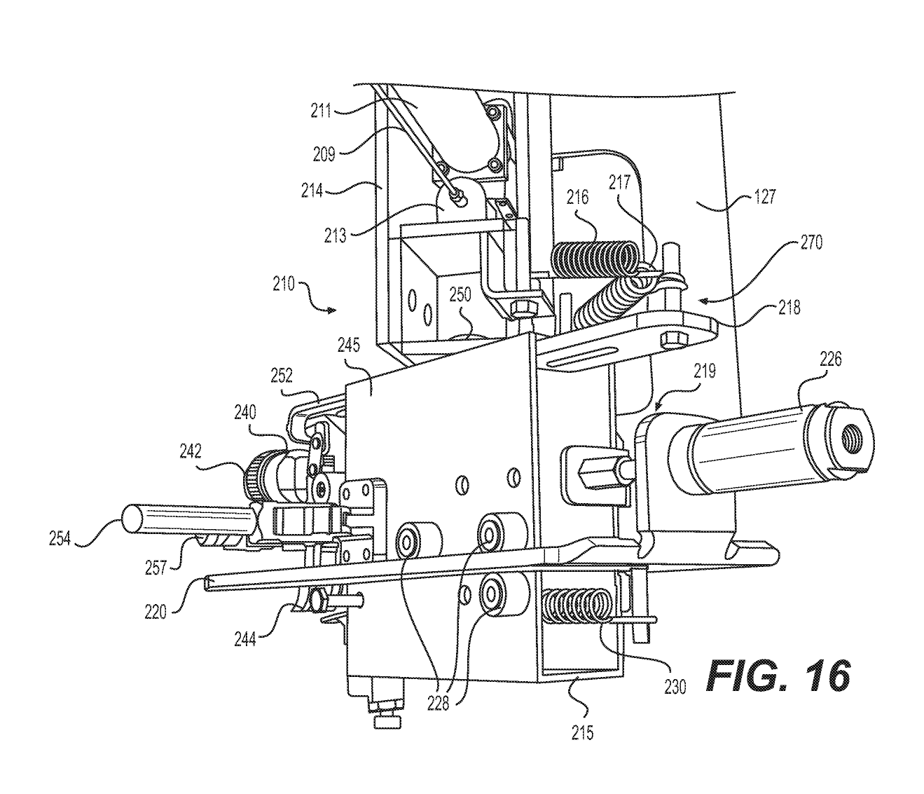

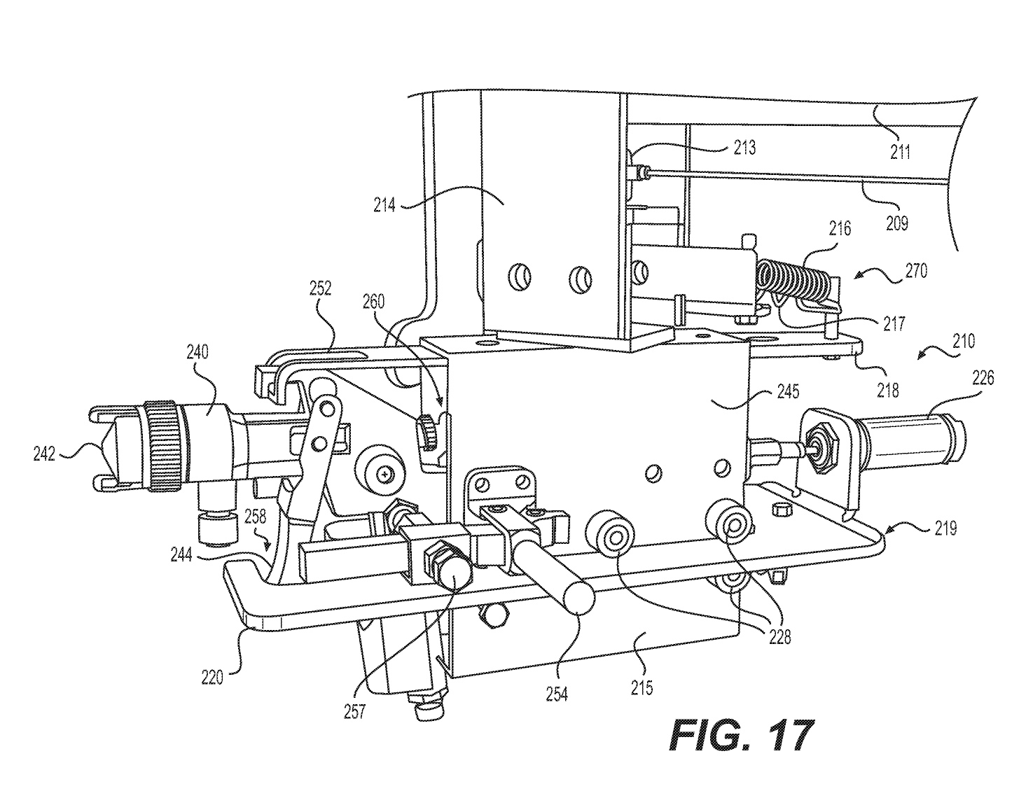

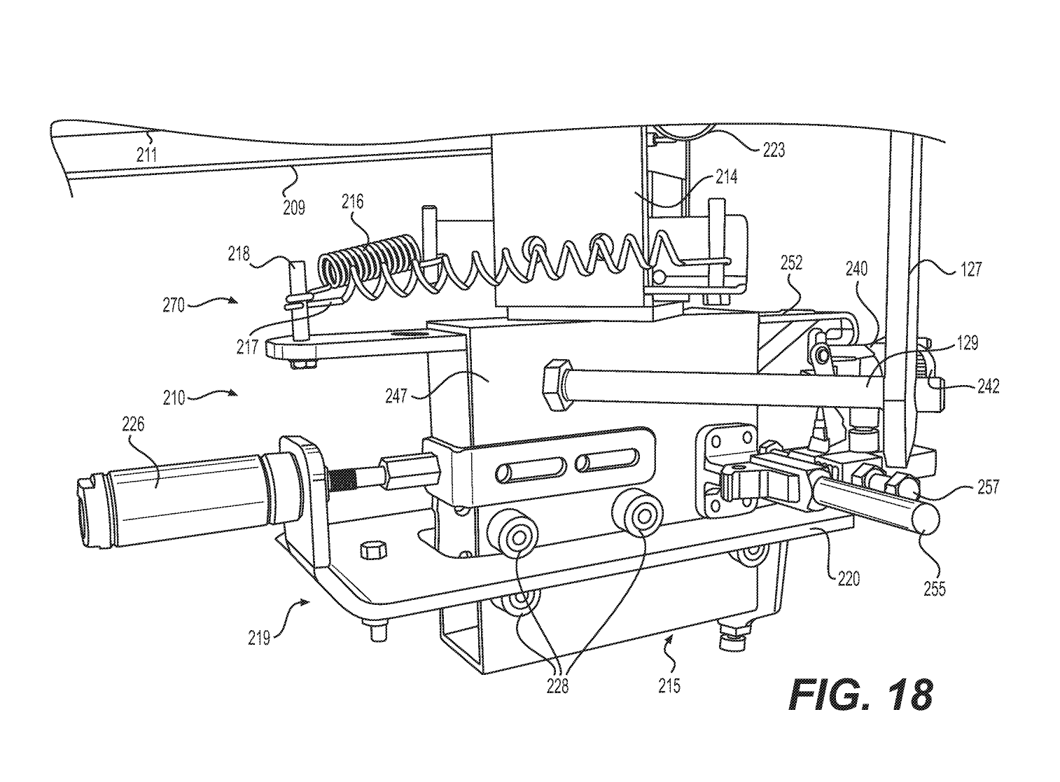

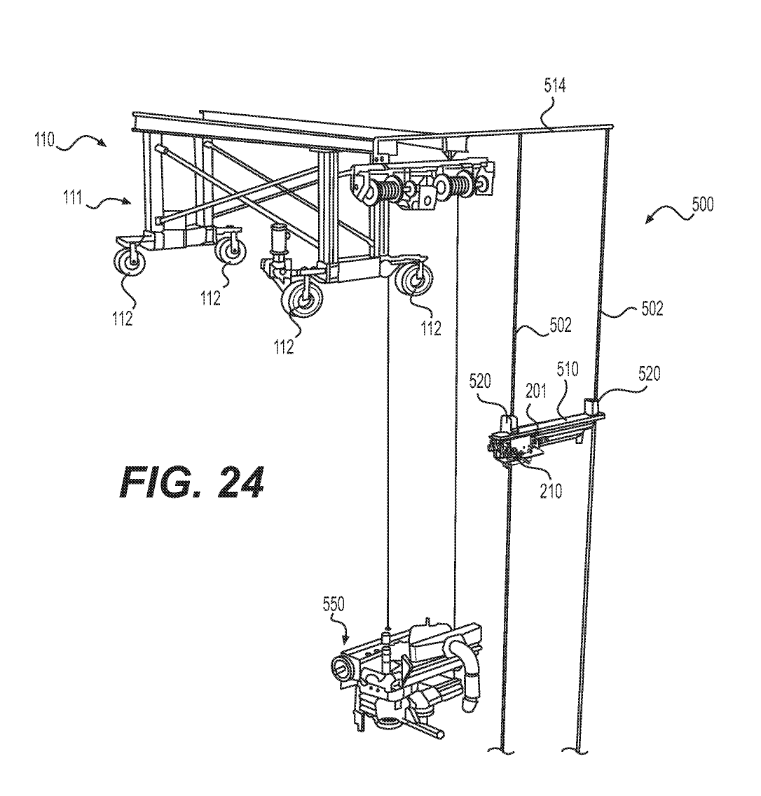

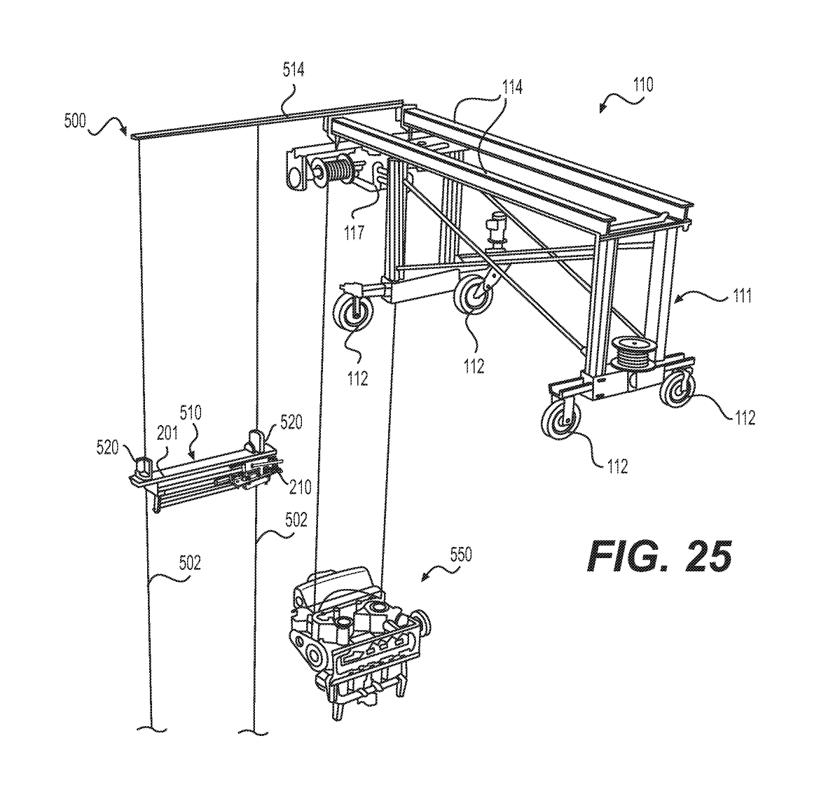

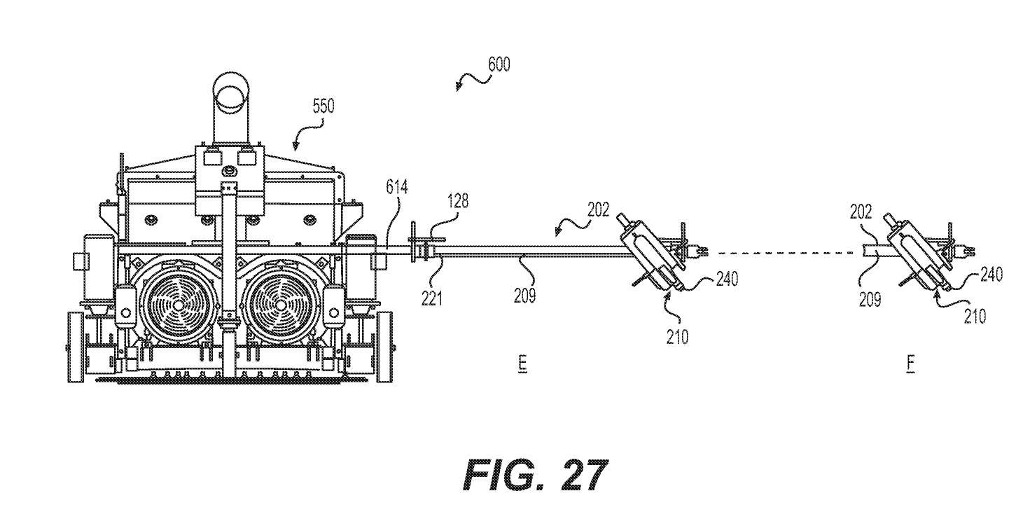

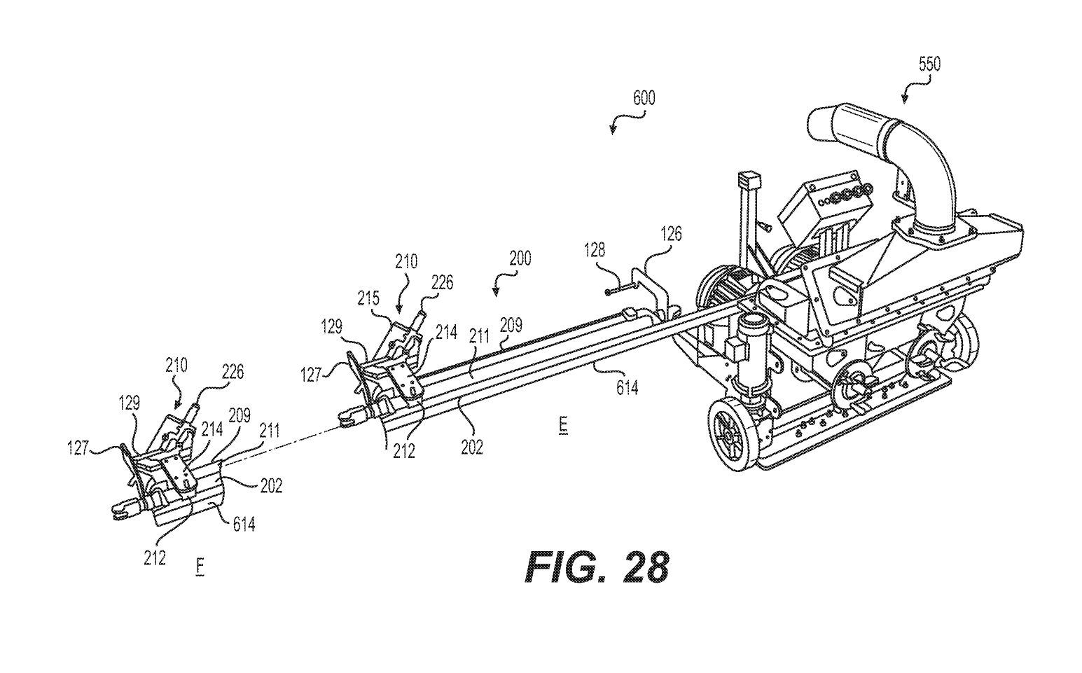

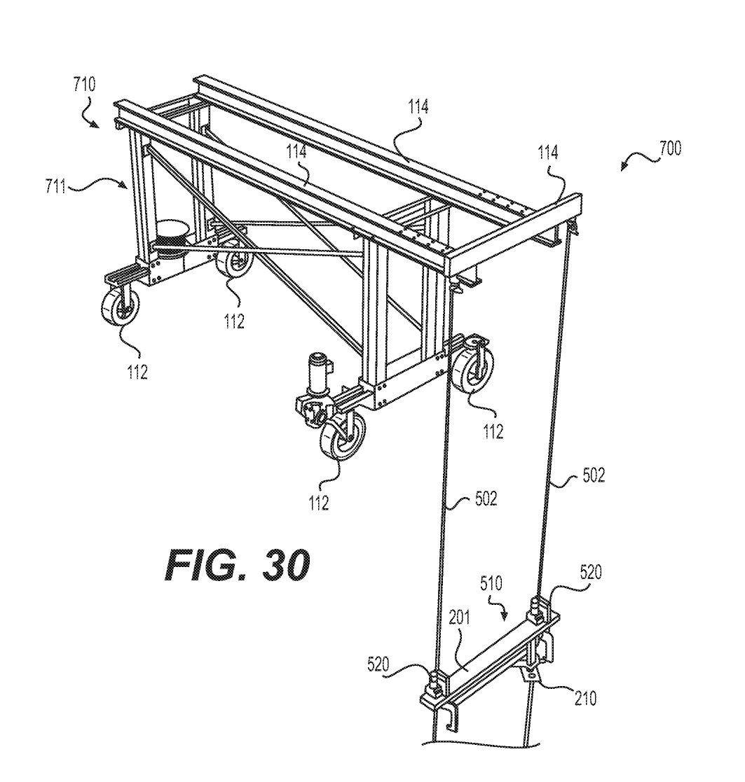

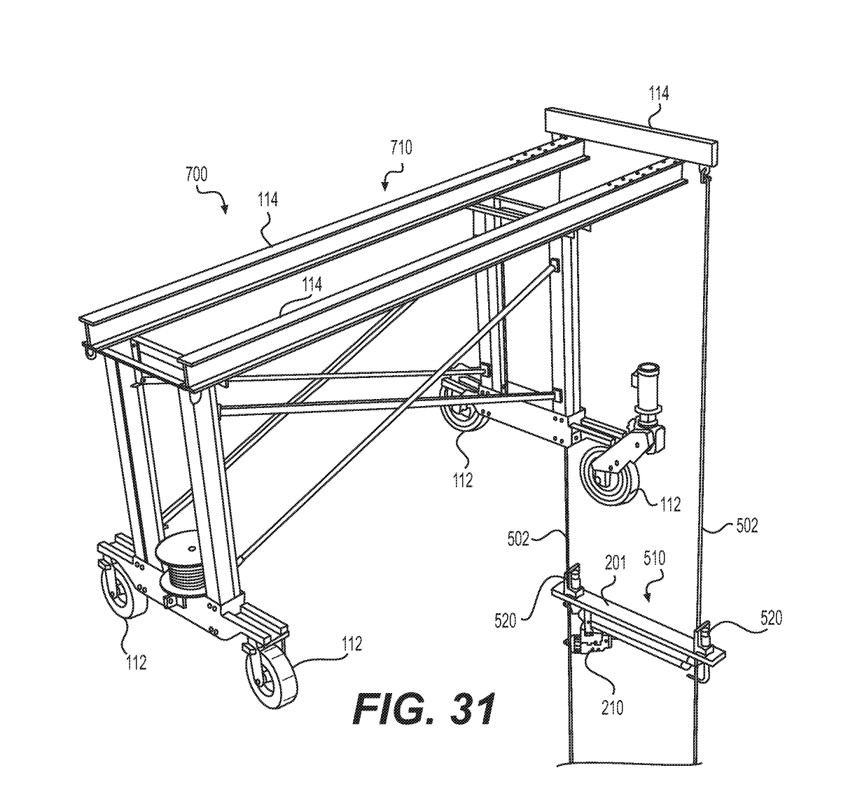

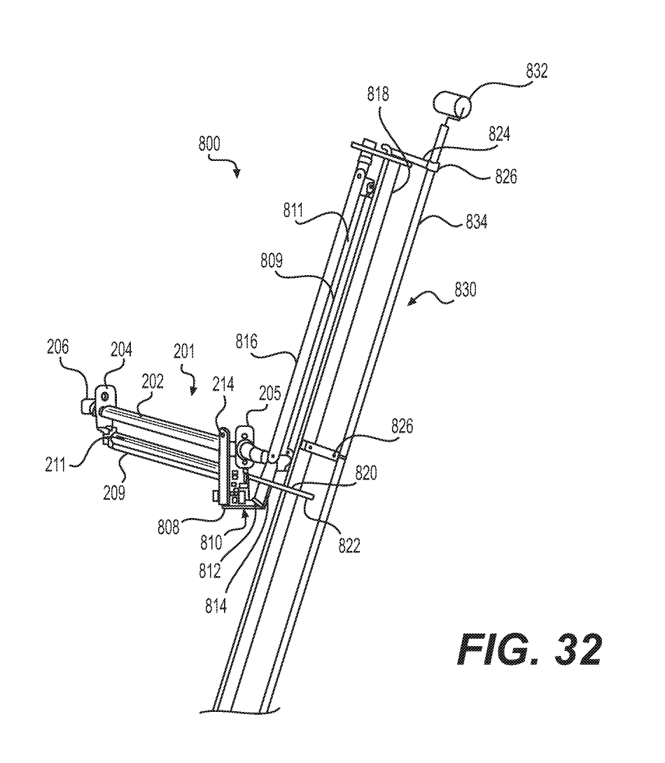

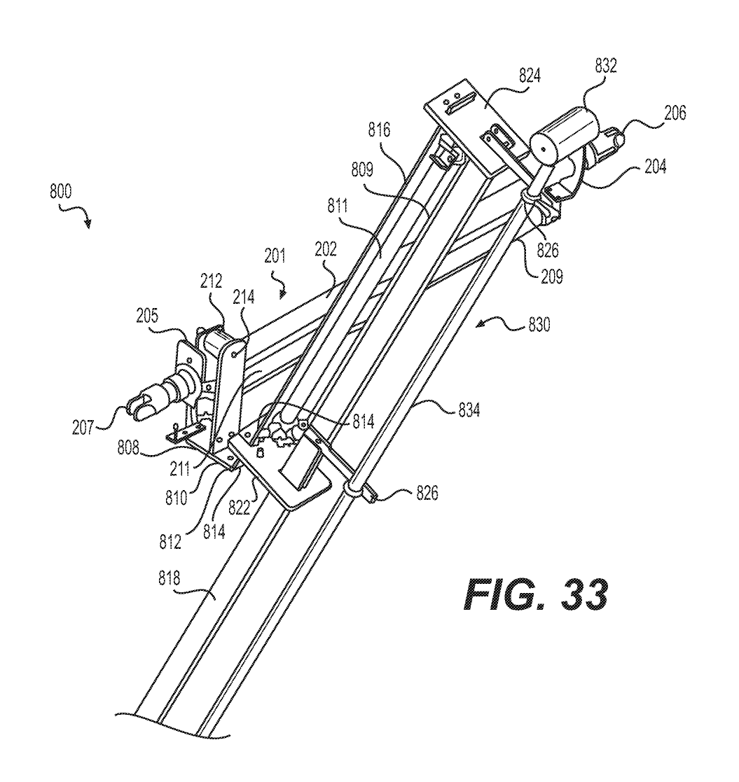

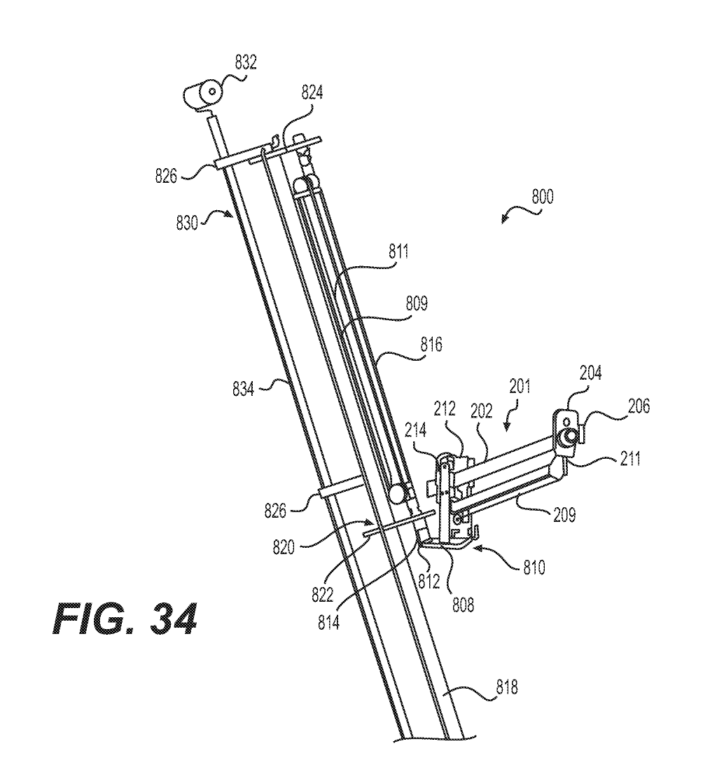

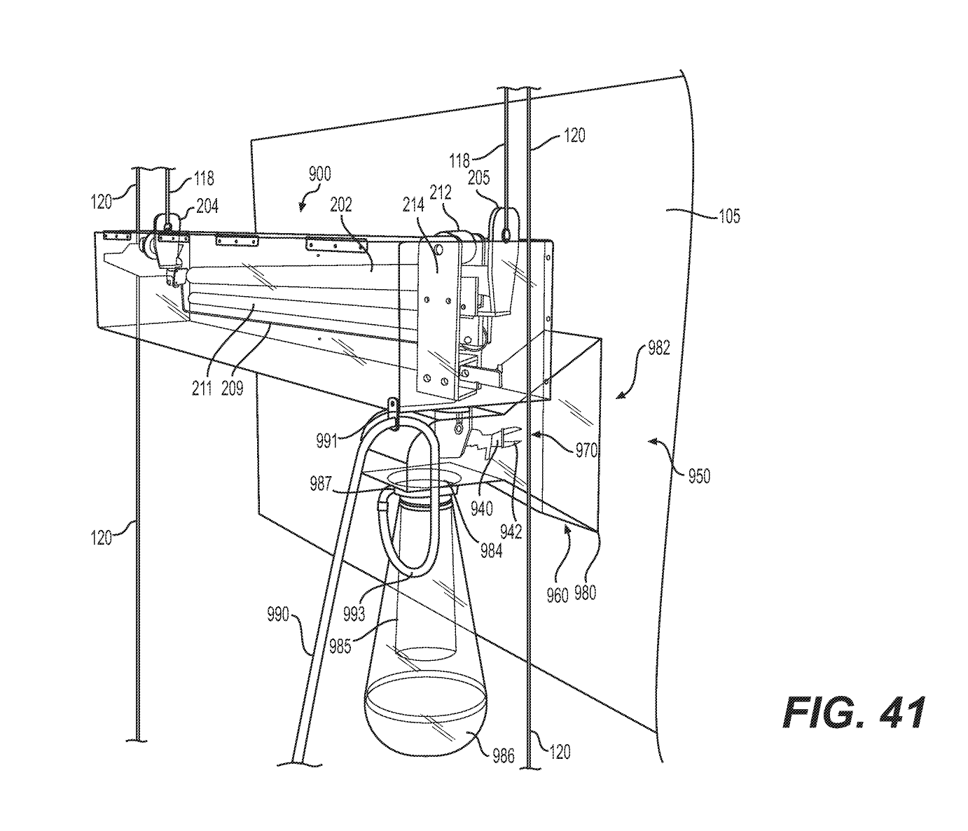

FIGS. 1-41 illustrate various embodiments and components of apparatus and systems encompassed by the present disclosure. As illustrated in FIGS. 1-3, a remote-controlled application system 100 is provided that can be used to apply paint or another fluidized material to a work surface 105 of a structure, such as the sidewall of a storage tank, and that can be controlled remotely by an operator using a remote control unit 107 to raise, lower, activate and deactivate the various components of the applicator system. The remote-controlled application system 100 allows for the controlled movement of an applicator, such as a spray gun, both vertically and horizontally adjacent one or more surfaces of a structure to which paint or another fluidized material is to be applied, as well as the activation and deactivation of the applicator while it is positioned adjacent the surface.

The remote-controlled application system 100 generally includes an applicator system 200 that is movably supported by a hoist system 116, shown positioned on the roof of the storage tank. The hoist system 116 includes a hoist motor 117 that is operably connected to one or more hoist drums 119 to which is connected one or more hoist lines 118 from which is suspended the applicator system 200. By activation of the hoist motors 117, the hoist drums 119 rotate either clockwise or counterclockwise so as to extend or retract the hoist lines 118, thereby raising or lowering the applicator system 200 along a vertical path to the desired position. The hoist system 116 is mounted on a hoist support 110, which, as shown in FIG. 3, can be a trolley 111 that includes one or more beams 114 on which the hoist system 116 is mounted. The trolley 111 is movably mounted on one or more castors or wheels 112 to allow for the repositioning of the applicator system 200 relative to the surface to which the fluidized material is to be applied. The positioning of the applicator system 200 relative to the work surface 105, which is shown as the sidewall of the storage tank, is aided by one or more stabilizers 120 that are mounted to the trolley 111 and extend down the length of the work surface 105, which is shown as the sidewall of the storage tank. Each stabilizer 120 is movably engaged by the applicator system 200 and anchored by an anchor 122. The cooperation of the applicator system 200 with the stabilizers 120 allows the relative distance between the applicator system 200 and the work surface 105 to be maintained as the applicator system 200 moves. Each anchor 122 is disposed on the ground or other suitable supporting surface and can include a well into which weight-imparting materials can be added, such as rock, brick, sand, dirt or other suitable materials. Each stabilizer 120 can comprise a stabilizing cable, as shown in FIG. 1, a chain, a pole, a track, and/or a plate that cooperate with the carriage 201 to stabilize the carriage 201 and to reduce and/or eliminate the lateral movement of the carriage 201 both when the carriage 201 is being moved vertically and is in positioned in a specified vertical alignment for conducting a fluidized material application cycle. The hoist line 118 can comprise a hoist cable, as shown in FIG. 1, a chain, a pole, and/or a track.

As shown in FIG. 2, each stabilizer 120 is adjustably connected to the anchor 122 by a winch 124 that can allow for the adjustment of the length of the stabilizer 120 and the application of the appropriate tension to the stabilizer 120 to maintain its position relative to the work surface.

As shown in FIG. 3, the remote-controlled application system 100 can comprise a hoist system comprising a pair of hoist drums 119, each operably connected to a hoist motor 117, and wherein a hoist cable 118 is operably connected to one of the hoist drums 119. The hoist drums 119 and hoist motor 117 are supported by the beams 114 of the trolley 111 to which is operably mounted a plurality of castors 112 that allow for the movement of the trolley 111. A pair of stabilizers 120 also is mounted on the trolley 111 and extends therefrom. When a work surface 105 is to receive an application of a fluidized material, the remote-controlled application system 100 can be aligned for implementation by placing the trolley 111 in position on the top of the storage tank so that the hoist lines 118, stabilizers 120 can be extended along the work surface 105, and the applicator system 200 mounted on the hoist lines 118 and operably engaged to the stabilizers 120 to allow for the controlled vertical movement thereof.

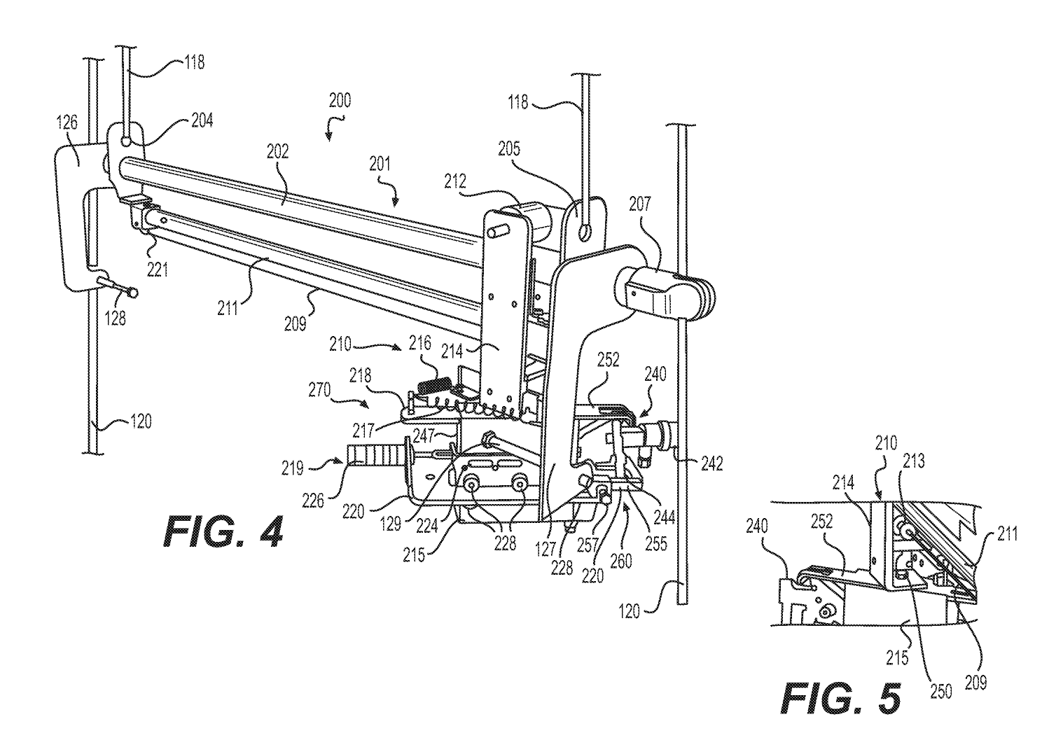

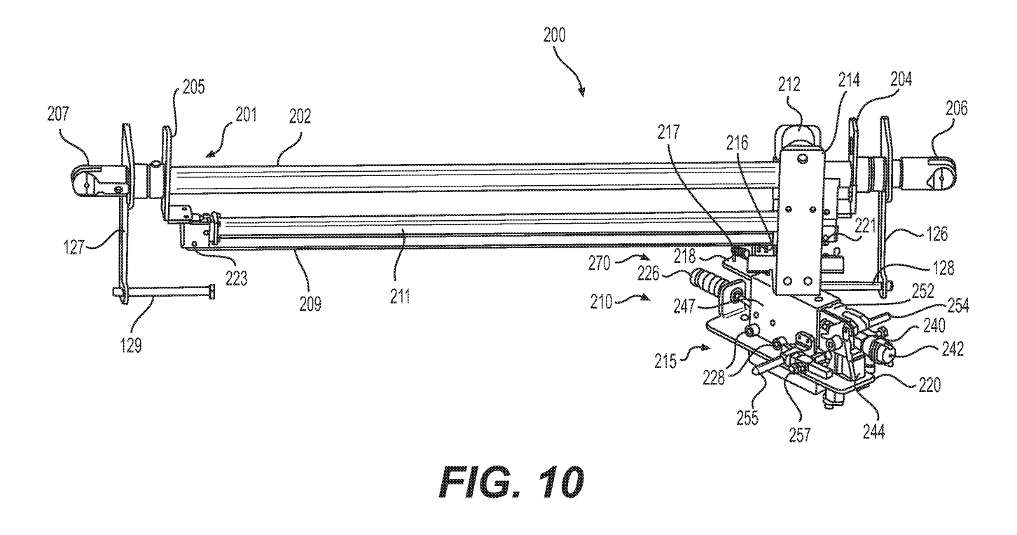

FIGS. 4-18 show an applicator system 200 encompassed by the present disclosure. The applicator system 200n includes a carriage 201 to which is movably mounted an applicator mount assembly 210. A separate hoist line 118 supports each of the opposed first and second ends of the carriage 201, and the carriage 201 is movably engaged with each of the stabilizers 120 on either end thereof so as to maintain the position of the applicator system 200 relative to a work surface 105. The carriage 201 includes a support body 202 having a first end and a second end. The support body 202 can comprise a beam or other suitable structure for supporting one or more other components of the applicator system 200. At the first end of the support body 202 is attached a first stabilizer guide 206, and at the second end of the support body 202 is attached a second stabilizer guide 207, as shown in FIG. 10. Each of the first and second stabilizer guides 206 and 207 engage a stabilizer 120 to allow for the stabilization of the applicator system 200. Also attached to the support body 202 are a first hoist bracket 204 and a second hoist bracket 205, each of which connects a hoist line 118 to the carriage 201. The applicator system 200 also includes a first striker 128 and a second striker 129. The first striker 128 is connected to the support body 202 by the first striker mount 126 and the second striker 129 is connected to the support body 202 by the second striker mount 127. Each of the first and second strikers 128 and 129 are shown as rods that are aligned to operably engage the applicator mount 215 to pivot the applicator 240. The present disclosure encompasses strikers of alternative configuration that can cooperate with the applicator mount to allow for the pivoting of an applicator 240 mounted to the applicator mount 215.

The applicator system 200 also includes an actuator 211 that drives the applicator mount assembly 210 along each stroke during operation. The actuator 211 can comprise a pneumatically controlled cable cylinder, as shown in FIG. 4. The present disclosure also encompasses systems and apparatus that comprise actuators comprising one or more alternative components that can impart motion to the applicator to position the applicator in an appropriate position during an application cycle. The actuator 211, shown in FIG. 4, comprises a first pulley 221 and a second pulley 223 rotatably mounted at either end of the actuator 211. A reciprocating cable 209 is operably connected to the first pulley 221 and the second pulley 223 and can move in a reciprocating manner on the first and the second pulleys 221 and 223 when a piston, not shown, disposed in the actuator 211 and to which either end of the reciprocating cable 209 is attached, is activated. A reciprocating cable mount 213, shown in FIG. 5, is attached to the reciprocating cable 209 and connects to the applicator mount assembly 210, thereby allowing for the movement of the applicator mount assembly 210 in a reciprocating motion from the first end of the carriage 201 to the second end of the carriage 201, when the reciprocating cable 209 moves.

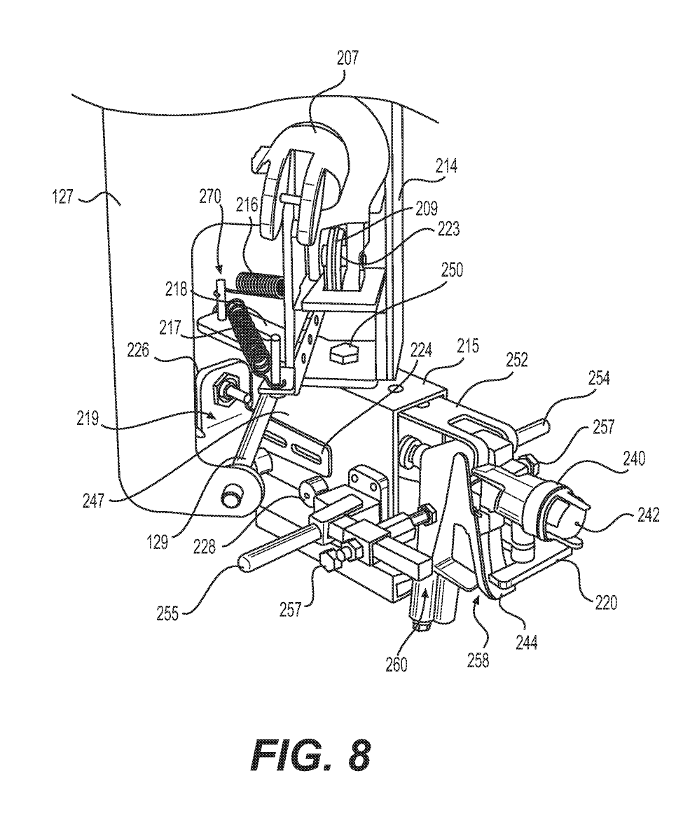

The applicator mount assembly 210 includes a support bracket 214 connected to and supported by roller 212, which movably engages support body 202 as the applicator mount assembly 210 reciprocatingly moves back and forth along the length of the carriage 201. The applicator mount assembly 210 also includes an applicator mount 215 rotatably mounted to and suspended from the support bracket 214. The applicator mount 215 is pivotally rotatable about an axis extending through both the applicator mount 215 and an applicator mount pivot pin 250, shown in FIGS. 8, 12, 14 and 16. The axis can be aligned vertically, when the applicator system 200 is configured in a remote-controlled application system 100 as shown in FIG. 1. The applicator mount 215 includes a first strike plate 245 and an opposed second strike plate 247. One of the first strike plate 245 and the second strike plate 247 are engaged at the end of an application cycle to adjust the alignment of the applicator mount 215 relative to the support bracket 214, so as to allow for the application of fluidized material to the surface at a non-perpendicular angle to the work surface 105 by the realignment of the fluidized material applicator 240 mounted to the applicator mount 215.

The positioning of the applicator mount 215 is facilitated by a positioning assembly 270 that comprises the applicator mount pivot pin 250, the first and the second strike plates 245 and 247, the first positioning spring 216 and the second positioning spring 217, the spring tension adjustment bracket 218, and the first and second strikers 128 and 129. The components of the positioning assembly 270 cooperate to align the applicator mount 215 in the appropriate alignment relative to a work surface 105 as the applicator mount assembly 210 moves through each stroke of an application cycle.

The applicator mount 215 also includes an applicator receiver assembly 260 comprising an applicator receiver opening 258, an adjustable applicator hanger 252, a first applicator clamp 254, and a second applicator clamp 255. The components of the applicator receiver assembly 260 cooperate to receive and securely hold a fluidized material applicator 240 in the proper alignment on the applicator system 200. A fluidized material applicator 240 can be mounted on the applicator system 200 by disposing the fluidized material applicator 240 in the applicator receiver opening 258 and engaging the fluidized material applicator 240 with the adjustable applicator hanger 252, which is movably adjustable to allow for the appropriate positioning thereof to receive applicators of various sizes. The fluidized material applicator 240 can then be aligned and secured in place within the applicator receiver assembly 260 by adjusting the first and the second applicator clamp 254 and 255 to engage the fluidized material applicator 240 and locking the first and the second applicator clamps 254 and 255 in position, thereby securing the fluidized material applicator 240. Each of the first and the second applicator clamps 254 and 255 include and an adjustment pin 257 that is movably aligned to engage a portion of the fluidized material applicator 240.

The fluidized material applicator 240 includes an applicator nozzle 242 from which a fluidized material can be directed and a trigger 244 that controllably activates the fluidized material applicator 240. The fluidized material applicator 240 is positioned and secured within the applicator assembly 260 to allow for the precise alignment of the applicator nozzle 242 relative to a work surface and the alignment of the trigger 244 with a trigger assembly 219. The present disclosure encompasses fluidized material applicators that include, but are not limited to, spray guns, rollers, brushes, hoses, jets, nozzles, and any other apparatus known for conveying and applying a fluidized material to a work surface.

The applicator mount 215 also includes a trigger assembly 219 with components that cooperate to activate and deactivate the trigger 244 of the fluidized material applicator 240. The trigger assembly 219 comprises a movable trigger operator 220 that releasably engages the trigger 244 when a fluidized material applicator 240 is disposed within the applicator receiver assembly 260. A plurality of support rollers 228 are mounted to the applicator mount 215 and cooperate with the trigger operator 220 to allow the trigger operator 220 to move from a first position of engagement with the trigger 244 to a second position of disengagement from the trigger 244. The trigger operator 220 is connected to a trigger actuator 226 that is operably engaged thereto and can move the trigger operator 220 between the first and the second positions. The trigger assembly 219 also includes a trigger operator spring 230 operably connected to the trigger operator 220 and that provides a counter force to the trigger operator actuator 226. When the trigger operator actuator 226 is not activated the trigger operator spring 230 moves the trigger operator 220 to the first position, thereby engaging the trigger 244 and generating a stream of fluidized material that exits the applicator nozzle 242 of the fluidized material applicator 240. The trigger operator actuator 226 can be an air cylinder with a supply of pressurized air supplied thereto and regulated so as to activate and deactivate the trigger operator actuator 226 at the appropriate times in the application cycle.

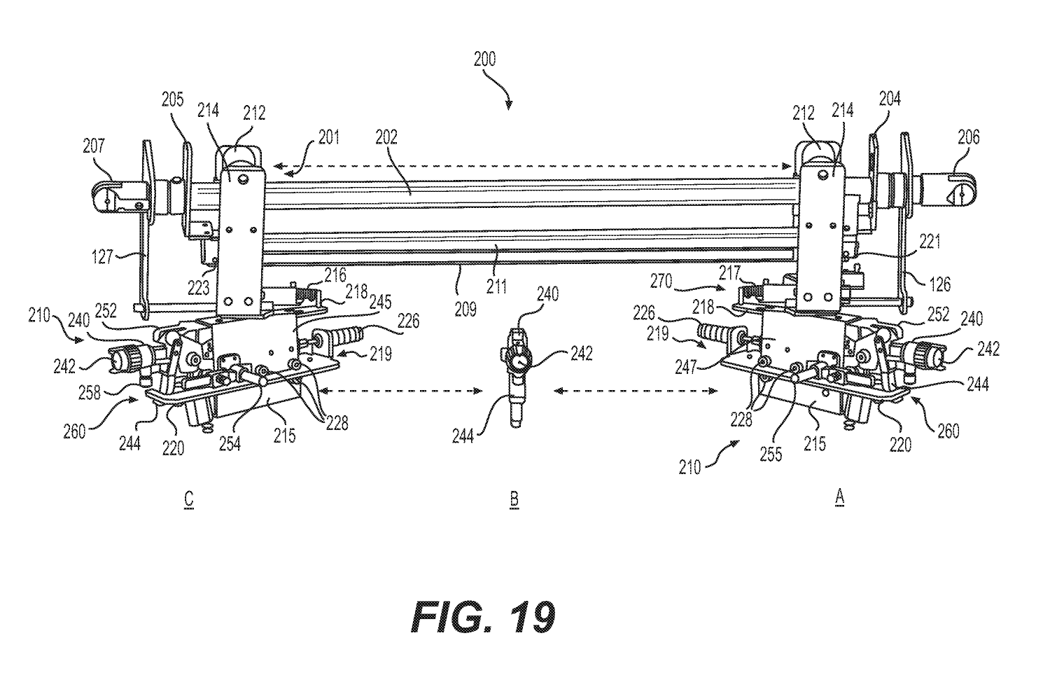

FIG. 19 shows a portion of the applicator system 200 and illustrates the movement and relative position of the fluidized material applicator 240 at various points along a reciprocating stroke of an application cycle. At the beginning of a stroke, the applicator mount assembly 210 is disposed at position A, where the applicator mount assembly 210 is aligned adjacent the first end of the carriage 201 adjacent the second stabilizer guide 206. In position A, the applicator mount 215 is aligned with the applicator nozzle 242 positioned in a non-perpendicular alignment with a work surface. When the applicator mount assembly 210 is in position A, the first striker 128 engages the first strike plate 245, thereby rotating the applicator mount 215 about the axis extending through the applicator mount pivot pin 250, resulting in the applicator nozzle 242 of the fluidized material applicator 240 being aligned at an angle obtuse to the actuator 211. When the applicator mount assembly 210 is in position A, the trigger operator actuator 226 is activated, thereby aligning the trigger operator 220 in a second position disengaged from the trigger 244 of the fluidized material applicator 240 allowing the fluid line of the applicator to clear from the last application stroke. The trigger operator actuator 226 then is deactivated, thereby resulting in the trigger operator 220 moving in the direction of the trigger operator actuator 226 by the tension of the trigger operator spring 230. The trigger operator 220 thereby engages the trigger 244 of the fluidized applicator 240 to cause the fluidized material applicator 240 to activate and to generate a stream of fluidized material, not shown, from the nozzle 242 directed at a work surface at an obtuse angle. The generation of the stream of fluidized material begins another stroke of the application cycle.

The dashed lines in FIG. 19 show the bi-directional movement of the applicator mount assembly 210 as the applicator mount assembly 210 moves from one end of the applicator system 200 to the opposed end thereof. For clarity of illustration, the fluidized material applicator 240 is shown at position B separate and apart from the applicator mount assembly 210 so as to illustrate the alignment of the fluidized material applicator 240 and nozzle 242 at the mid-point of a stroke in the application cycle. In operation, the fluidized material applicator 240 remains mounted to the application mount assembly 210 throughout the application cycle. As such, when the fluidized material applicator 240 is in position B, the application mount assembly 210, to which the fluidized material applicator 240 is mounted, is aligned at approximately the mid-point of the carriage 201. The orientation of the fluidized material applicator 240 shown at position B in FIG. 19 is the orientation that the fluidized material applicator 240 maintains throughout each stroke of an application cycle until one of the first and second strikers 128 and 129 engage the first and second strike plates 245 and 247, respectively, thereby rotating the orientation of the applicator nozzle 242 from an alignment that is substantially perpendicular to the path of the applicator mount assembly 210 to an alignment that is substantially obtuse thereto. As shown, in position B and intermediate positions the applicator nozzle 242 is aligned substantially perpendicular to the actuator 211 so as to provide a stream of fluidized material to a work surface at an angle substantially perpendicular to the surface. At position B, and all intermediate positions between position A and position C, the trigger 244 remains activated by the trigger operator 220 so as to provide a continuous stream of fluidized material from the applicator nozzle 242 at position B and all positions intermediate to positions A and C.

At position C, the alignment of the applicator mount assembly 210 is generally a mirror image the alignment of the applicator mount assembly 210 at position A. At position C, the second strike plate 247 engages the second striker 129 to cause the applicator mount 215 to rotate about the axis extending through the applicator mount pivot pin 250. Thus, the applicator mount 215 is pivotable through a range of approximately 90° with the pivot at both position A and position C being about 45°. When the applicator mount assembly 210 is at position C, the trigger operator actuator 226 is activated, thereby placing the trigger operator 220 in the second position, whereby the trigger 244 is disengaged so as to end the stream of fluidized material at the end of the stroke. The applicator mount assembly 210 is reciprocatingly movable along a path between positions A and C and through position B. The path of the applicator mount assembly 210, as delineated by the reciprocal movement of the roller 212 can be substantially rectilinear.

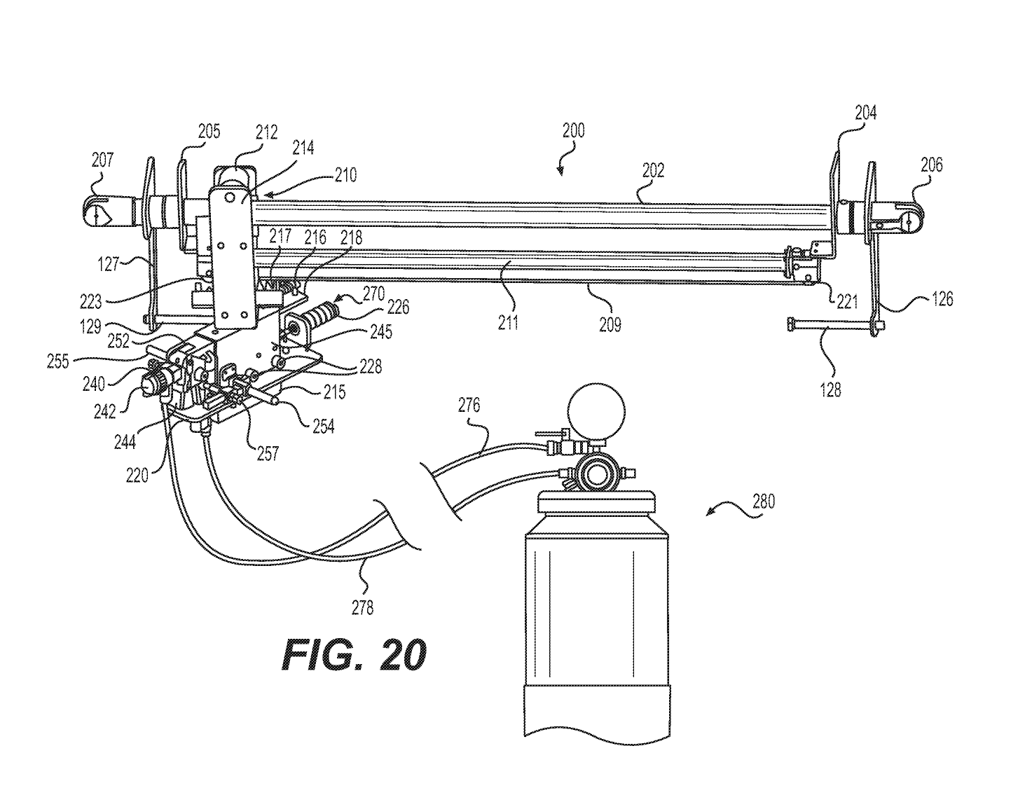

As illustrated in FIG. 20, the applicator system 200 is operably connected to a fluidized material receptacle assembly 280. The fluidized material applicator 240 mounted on the applicator mount assembly 210 is in fluid communication with the fluidized material receptacle assembly 280 via a material line 276 and an air line 278. When the trigger operator 220 activates the trigger 244, a fluidized material contained in the fluidized material receptacle assembly 280 is fed through the material line 276 to the fluidized material applicator 240, and pressurized air is supplied to the fluidized material applicator 240 through the air line 278. The fluidized material applicator 240, the material line 276, the fluidized material receptacle assembly 280, and the air line 278 are in fluid communication with each other and cooperate to provide a flow of fluidized material to the fluidized material applicator 240. The present disclosure also encompasses systems and methods wherein the fluidized material is provided to the fluidized material applicator through means other than compressed air, such as, but not limited to, other compressed gas assemblies, and pump assemblies.

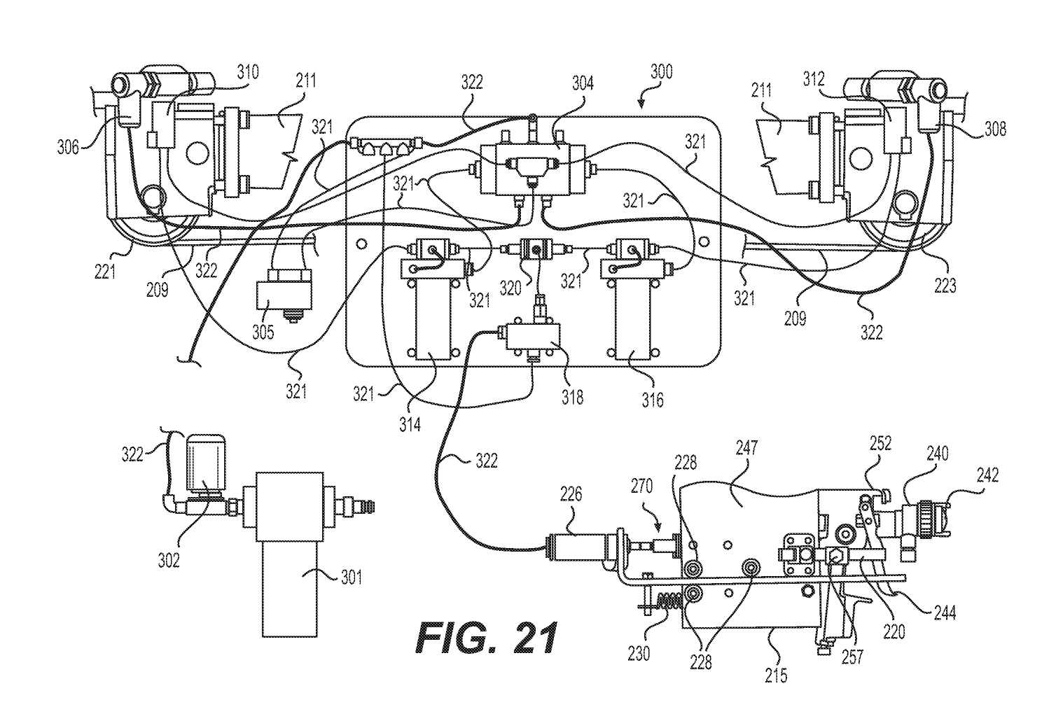

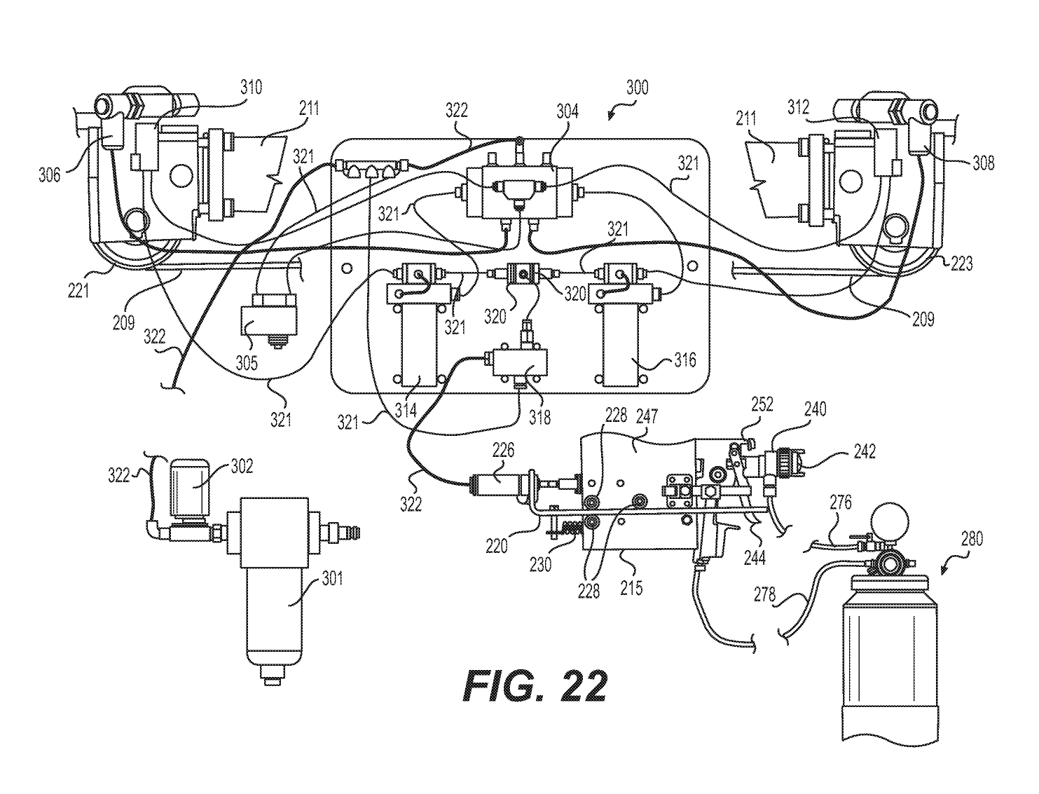

FIGS. 21 and 22 illustrate a control system 300 that can be used to control the operation of the apparatus and systems encompassed by the present disclosure. Since the apparatus, systems and methods encompassed by the present disclosure can be used in conjunction with flammable materials or used in areas where flammable materials can be present, the control system 300 is illustrated as a pneumatic system that does not rely upon electricity. However, the present disclosure also encompasses control systems that incorporate electrical components. The control system 300 includes a supply of compressed air or other compressed gas or fluid, not shown, that is in fluid communication with and supplied to the components of the control system 300 through an air filter 301 and regulated by a pressure regulator valve 302. The filter 301 removes contaminates and moisture from the air supply and the pressure regulator valve 302 maintains the air supply at the appropriate pressure level, which can be, but is not limited to, about 40 p.s.i. (about 275 kPa). The air is conducted to the various components of the control system 300 by a series of 0.25-inch (6.4 mm) airlines 322 and 0.156-inch (3.96 mm) air lines 321. The air filter 301 and the pressure regulator valve 302 are in fluid communication with a directional valve 304 that, in turn, is in fluid communication with a first sensor valve 310, a second sensor valve 312, a first time delay valve 314, a second time delay valve 316, and a second flow control valve 308. The directional valve 304 directs the supply of air to the various connected valves including supplying air to the second flow control valve 308 mounted on the actuator 211. Air flows through the second flow control valve 308 to the actuator 211, thereby pushing a piston, not shown, disposed in the actuator 211. The second flow control valve 308 is adjusted to provide a predetermined flow of air to the piston so as to move the piston at a predetermined speed.

The ends of the reciprocating cable 209 is connected to the piston, and, thus the reciprocating cable 209 moves in conjunction with the movement of the piston as the piston is pushed by the airflow supplied thereto through the second control valve 308.

As the piston moves, the reciprocating cable 209 reciprocates backward and forward around the first and the second pulleys 221 and 223. Since the applicator mount assembly 210 is connected to the reciprocating cable 209 by the reciprocating cable mount 213, the applicator mount assembly 210 also reciprocatingly moves laterally backward and forward between the opposing ends of the applicator system 200. When the piston has been pushed to the end of its path within the cable cylinder 209 at the end of a stroke, the first sensor valve 310 senses an increase in internal air pressure and then, in turn, pressurizes the first time delay valve 314 by increasing the flow of air thereto. The first and the second time delay valves 314 and 316 are both air accumulator valves that create a time delay at the end of each stroke, thereby providing sufficient time for the trigger operator actuator 226 to deactivate the trigger operator 220, thereby releasing the trigger 244 and stopping the flow of fluidized material from the applicator nozzle 242 of the fluidized material applicator 240 at the end of the stroke. The trigger operator actuator 226 is in fluid communication with a pilot valve 318 that controls the supply of air thereto. When the piston has reached the end of a stroke, either the first or the second sensor valve 310 and 312, as appropriate, supply air to the shuttle valve 320, which, in turn, supplies air to the pilot valve 318. The pilot valve 318, in turn, supplies air to the trigger operator actuator 226, thereby activating the actuator 226, which moves the trigger operator 220 to a second position where the operator 220 is disengaged from the trigger 244 of the fluidized material applicator 240. The flow of fluidized material is thereby stopped and a new stroke can begin. At the beginning of a new stroke, either the first or the second time delay valves 314 and 316, as appropriate, supply air to the directional valve 304, which, in turn, supplies air through either the first or the second flow control valves 306 and 308 to supply air to the piston so as to commence a new stroke. The control system 300 also includes an on/off switch 305, whereby the control system 300 can be activated or deactivated.

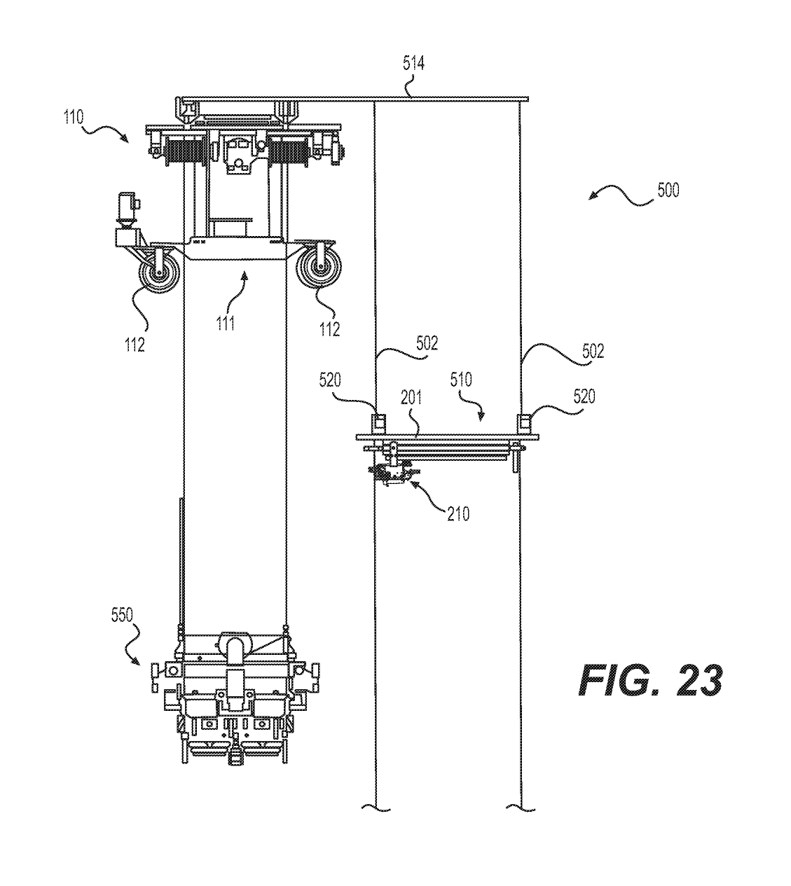

FIGS. 23-25 illustrate another remote-controlled application system 500 encompassed by the present disclosure. The remote-controlled application system 500 includes a hoist support 110 that comprises a trolley 111 supported on a plurality of casters or wheels 112. The hoist support 110 can be configured to support a blast-cleaning machine 550, as well as an adjustable support arm 514 from which an applicator system 510 can be suspended. The applicator system 510 can include a carriage 201 that supports a movable applicator mount assembly 210 as described herein. However, instead of separate hoist lines and stabilizers, the remote-controlled application system 500 can include a single pair of cables 502 aligned to receive apposing ends of the applicator system 510. The applicator system 510 can include a traction hoist 520 disposed on each of the opposing ends of the carriage 201 and operably connected to one of the pair of cables 502. Each traction hoist 520 can releasably engage one of the cables 502 to allow for the vertical movement of the applicator system 510 and, when engaged to the cable 502, provide for the stabilization of the applicator system 510 in position relative to a work surface to which fluidized material can be applied by the remote-controlled application system 500. The length of the adjustable support arm 514 can be adjusted to provide for the appropriate positioning of the applicator system 510 relative to a work surface. The remote-controlled application system 500 can be operated remotely by an operator using a remote control 107 to apply a fluidized material to a surface that is elevated or otherwise difficult to access by an operator using a manual applicator system. The remote-controlled application system 500 can be used in similar situations as the remote-controlled application system 100, such as on buildings, storage tanks, and reactor vessels. The present disclosure also encompasses systems and methods that include a traction hoist used independently of a blast system and blast system support apparatus. In such systems and methods, a traction hoist can be suspended from a trolley that does not support a blast system or any other maintenance system.

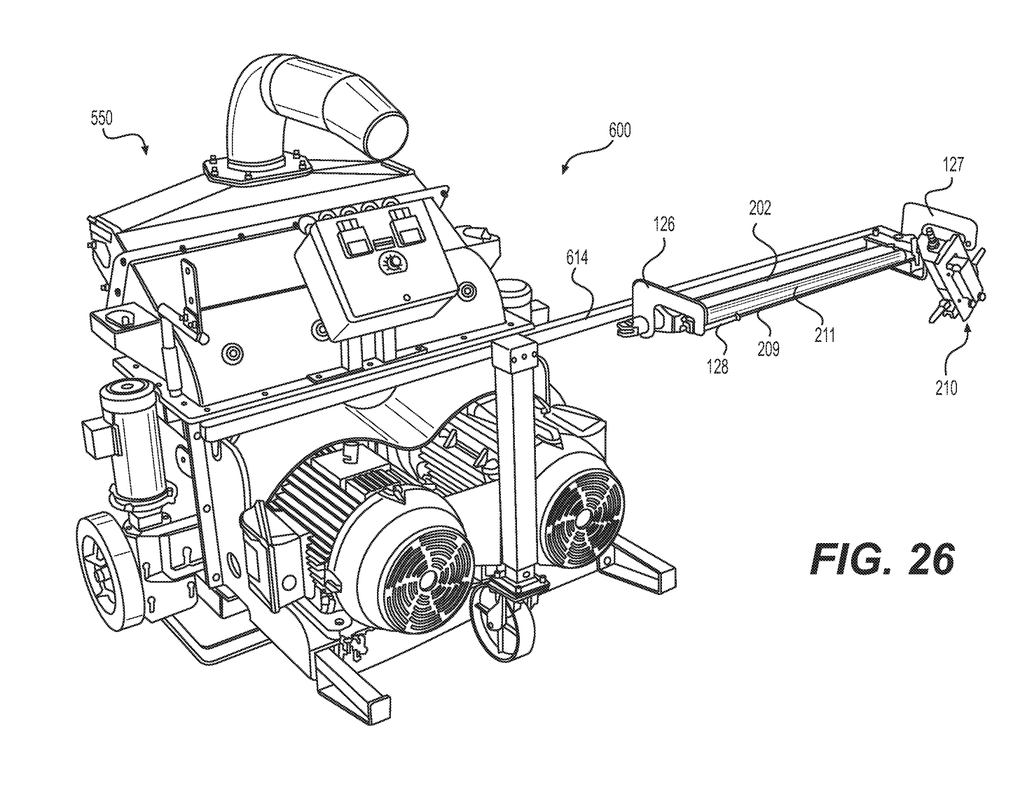

The present disclosure also encompasses apparatus and systems that are configured to apply fluidized material to horizontal surfaces. FIGS. 26-28 illustrate an applicator system 600 that encompasses aspects of the present disclosure. While he applicator system 600 is illustrated as mounted on a movable support fixture, such as blast machine 550, it should be understood that the applicator system 600 can be mounted on any suitable fixture, cart or movable support structure that allows for the movement and support of the applicator system 600 on a horizontal surface, such as a floor or deck.

The applicator system 600 includes an adjustable support arm 614 mounted to and extending from the blast machine 550. The adjustable support arm 614 is adjustable between a first position E and a second position F, as well as intermediate positions there between. In the first position E, the applicator system 600 is aligned proximal to the support fixture, and in the second position F, the applicator system 600 is aligned distal to the support fixture. The adjustable support arm 614 supports the other components of the applicator system 600, such as a support body 202, an actuator 211, a reciprocating cable 209, and an applicator mount assembly 210 to which is mounted a fluidized material applicator 240. The applicator system 600 can include the components as described herein and be aligned to provide a fluidized material to a surface disposed under the applicator system 600 such as a floor. The movable support fixture can be moved to different positions to allow for the applicator system 600 to be used to apply fluidized material across all or a portion of a horizontal surface. The control system 300 can be used in conjunction with the other components of the applicator system 600 to provide for a reciprocating stream of fluidized material.

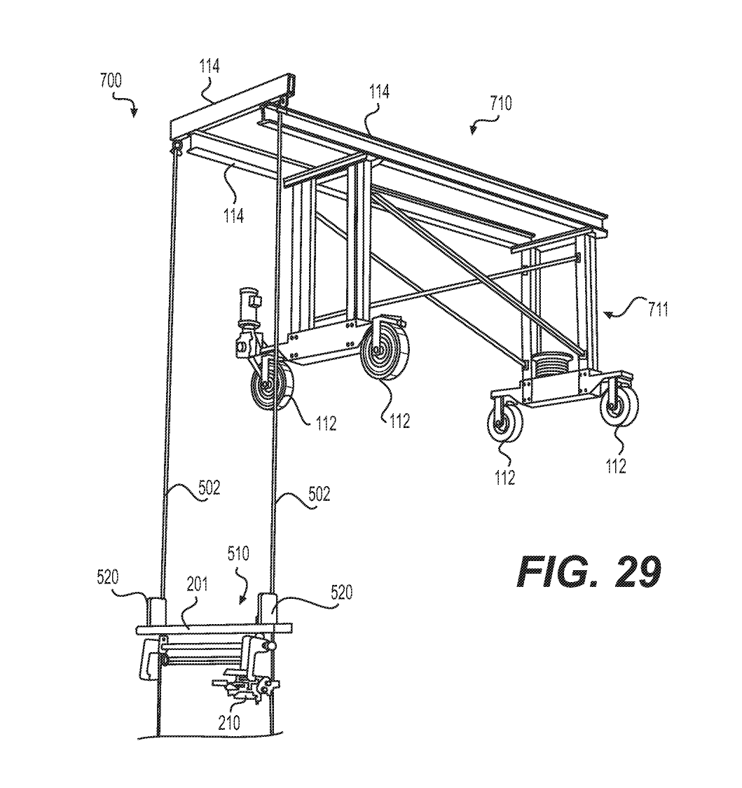

FIGS. 29-31 illustrate yet another embodiment of the systems encompassed by the present disclosure. The remote-controlled application system 700 includes an applicator system 510 as described above with a traction hoist 520 disposed on each of the opposed ends of a carriage 201 and operably connected to one of the pair of cables 502. A hoist support 710 is provided and from which the applicator system is suspended. The hoist support 710 includes a trolley 711 mounted on a plurality of wheels or castors 112 and includes support beams 114 from which the cables 502 are suspended. The hoist support 710 is configured to support and move only the applicator system 510 and not other devices.

FIGS. 32-36 illustrate an accessory applicator system 800 that can be used in conjunction with or separate from the applicator systems described herein. The accessory applicator system 800 can be used to apply a fluidized material to a surface by the use of a roller, brush, pad or other non-spray applicator. The accessory applicator system 800 includes an applicator mount assembly 810 by which the accessory applicator system 800 can be mounted to the carriage 201 of the applicator system 200 or other suitable support mechanism. When used in conjunction with the applicator system 200, the accessory applicator system 800 can be operably connected to the carriage 201, the applicator mount 215 is not included on the carriage 201, but is, instead, detached from the support bracket 214 and is replaced with the applicator mount assembly 810 of the accessory applicator system 800. The applicator mount assembly 810 includes a first plate 808 detachably connected to the support bracket 214 by a fastener, a hinge 812 operably connected to the first plate 808, and a second plate 814 attached to the hinge 812 and operably connected thereby to the first plate 808. The second plate 814 can pivotally rotate about the hinge 812 relative to the first plate 808 to impart an axis of motion to the accessory applicator system 800. An applicator mount assembly arm 816 is mounted to and supported by the second plate 814 of the applicator mount assembly 810. The applicator mount assembly arm 816 supports an actuator 811, such as a cable cylinder as shown in FIG. 32, that can be aligned generally parallel to the applicator mount assembly arm 816. A movable accessory applicator arm 818 is operably connected to the movable cable 809 that forms a part of actuator 811. The movable accessory applicator arm 818 can be disposed in a track 820 that includes a first track guide 822 and a second track guide 824. The first and second track guides 822 and 824 of the track 820 can cooperate with the accessory applicator arm 818 to align the accessory applicator arm 818 in the proper orientation as the accessory applicator arm 818 moves. Attached to the movable accessory applicator arm 818 are one or more clamps 826 that secure a fluidized material applicator 830 when operably connected to the accessory applicator system 800.

In FIGS. 32-35, the fluidized material applicator 830 is shown as a roller 832 mounted on a shaft 834, but the present disclosure also encompasses other accessories, such as, but not limited to, brushes, pads, and other accessories that can be used to apply a fluidized material to a surface and that can be operated using the accessory applicator system 800 disclosed herein. The fluidized material applicator 830 is secured to and moves with the accessory applicator arm 818, which is operably connected to the cable 809 of the actuator 811. Accordingly, when the cable 809 reciprocates in the actuator 811 both the accessory applicator arm 818 and the fluidized material applicator 830 move with the cable 809.

The applicator mount assembly arm 816 is movable along a range of motion by the pivoting of the hinge 808. In one aspect, the applicator mount assembly arm 816 can have a range of motion of about 90°. In another aspect, the applicator mount assembly arm 816 can have a range of motion of about 180°. In this manner, the fluidized material applicator 830 can be brought into position adjacent a work surface 105, such as a storage tank side wall, and securely aligned there via gravity as it moves through its reciprocating strokes.

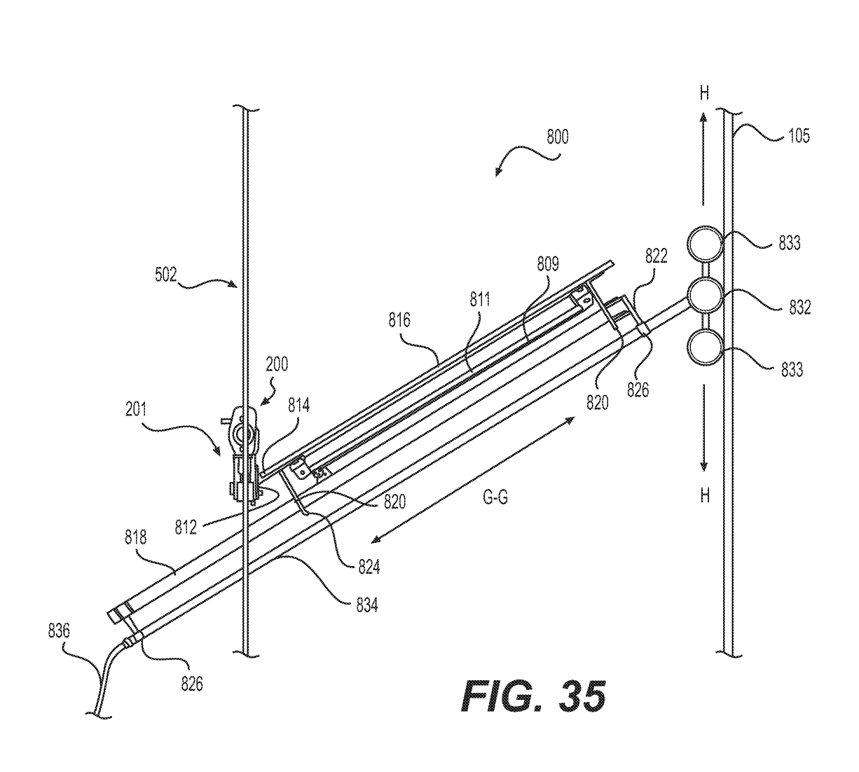

As shown in FIG. 35, the second plate 814 can rotate about the hinge 812 until the rollers 832 and 833, which are mounted in the accessory applicator system 800, are in contact with the work surface 105. The accessory applicator system 800 is mounted to the carriage 201, which, in turn is supported by cable 502. When operating, the accessory applicator system 800 can move reciprocally the roller 832 along a path delineated as GG, and the carriage 201 can move the roller 832 vertically along the path delineated as HH. Additionally, the applicator system 200 can move the accessory applicator system 800 in along the path delineated by AC, illustrated in FIG. 19 that is substantially perpendicular to the path HH. Accordingly, the rollers 832 and 833 can be moved vertically, horizontally and along a third axis of motion when operably connected to the accessory applicator system 800. A fluidized material can be fed through feed line 836 through the handle 834 to the rollers 832 and 833 and then applied to the work surface 105 by the rollers 832 and 833.

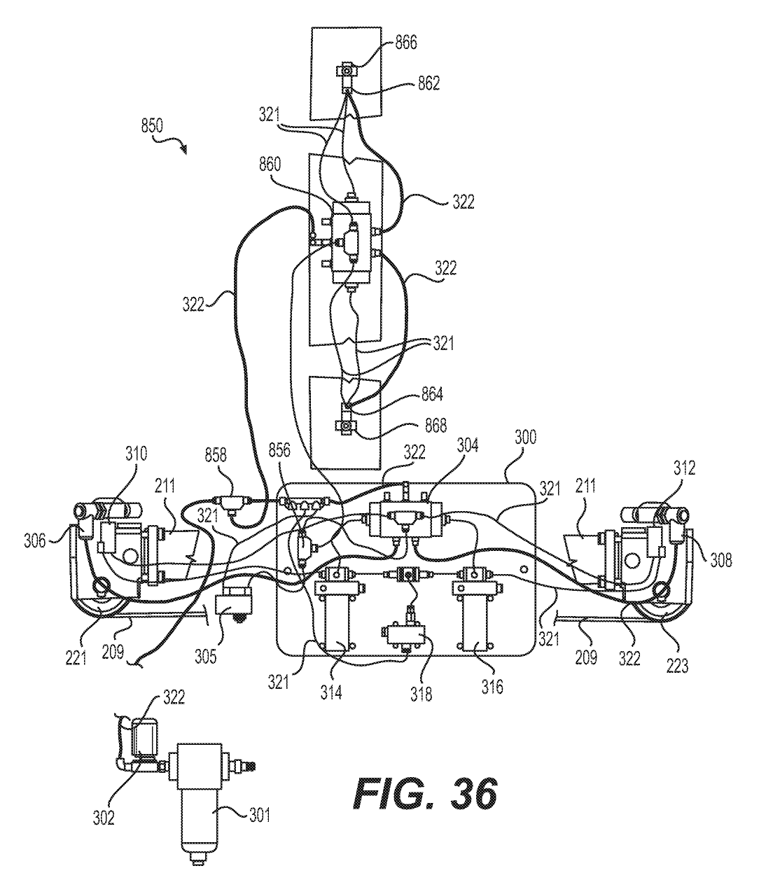

FIG. 36 illustrates the control system 850 that can be operably connected to the accessory applicator system 800 to control the operation thereof. The control system 850 can be pneumatically powered with air to avoid the use of electricity in flammable or otherwise hazardous areas. The control system 850 includes many of the components of the control system 300 illustrated in FIG. 21. The control system 850 includes a t-valve 858 operably connected to the control system 300 and including airline 322 in fluid communication with the t-valve 858 and leading to a directional valve 860, which, in turn, is operably connected to and in fluid communication with a first flow control valve 862 and a second flow control valve 864. The first and the second flow control valves 862 and 864 are operably connected to and in fluid communication with the actuator 811. The control system 850 also includes a first sensor valve 866 and a second sensor valve 868, each of which is operably connected to and in fluid communication with the actuator 811. The control system 300 can be activated when the accessory applicator system 800 is positioned to apply fluidized material to a work surface. When activated, the control system 300 directs air through the t-valve 858 and through the airline 322 to the directional valve 860, which in turn directs air in a reciprocating fashion alternatively to the first directional valve 862 and then to the second directional valve 864. When air is directed to the first directional valve 862, the air then is directed to one end of the actuator 811, thereby activating the actuator 811 and causing the reciprocating cable 809 to move in a downward direction. When the reciprocating cable 809 reaches the end of the downward stroke, the second sensor valve 868 is activated, thereby causing the flow of air through the first flow control valve 862 to cease and a flow of air to commence from the directional valve 860 to the second flow control valve 864. Air flows from the second flow control valve 864 to the actuator 811, thereby causing the reciprocating cable 809 to move upward. When the reciprocating cable 809 reaches the top of the stroke the first sensor valve 866 is activated, which in turn activates the directional valve 860, thereby stopping the flow of air to the second flow control valve 864 and commencing air flow to the first flow control valve 862, beginning another stroke. The change in air flow thereby causes the rollers 832 and 833 to move upward and downward in reciprocal strokes so as to apply fluidized material to a work surface 105, such as a wall of a tank, in a uniform manner. As the rollers 832 and 833 move up and down, the accessory applicator system 800 can also be moving from side-to-side by the reciprocating movement of the cable 209 to which is operably connected the applicator mount assembly 810. Control of the accessory applicator system 800 can be executed remotely using a remote control device operably integrated with the control system 850.

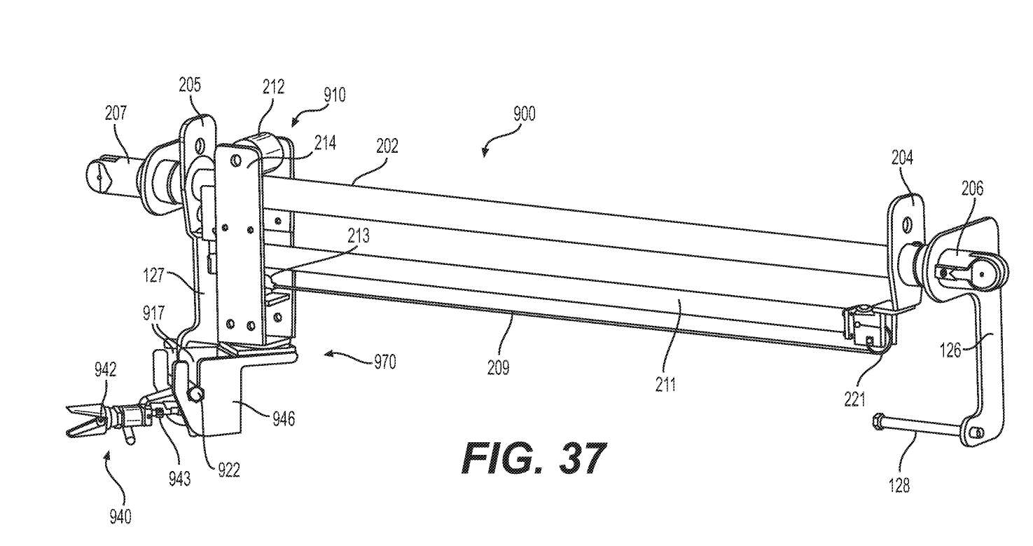

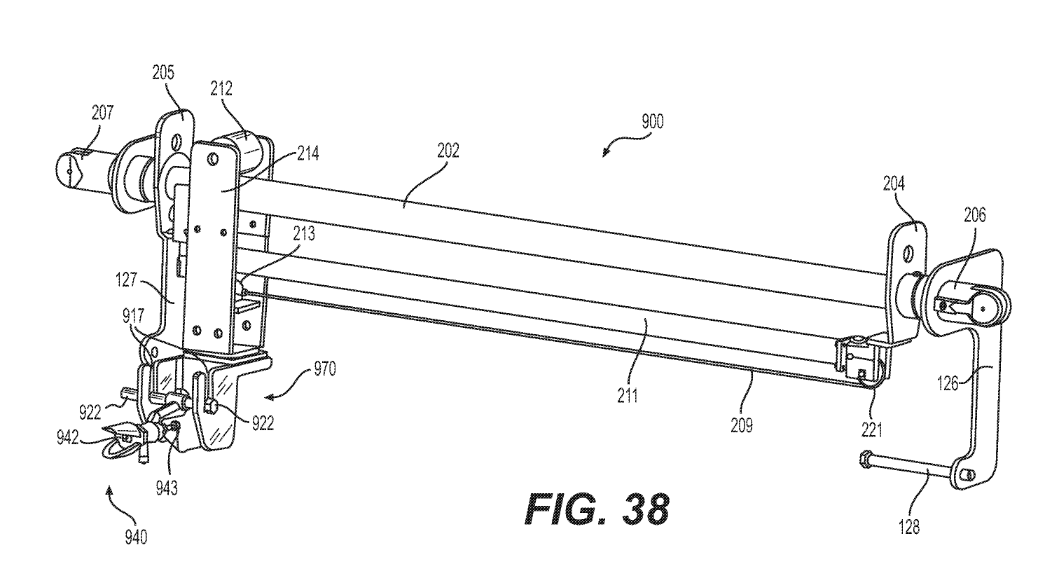

FIGS. 37 and 38 illustrates another alternative applicator system 900 encompassed by the present disclosure. The applicator system 900 comprises a carriage comprising a support body 202 to which is movably mounted an applicator mount assembly 910. The carriage can be suspended from one or more hoist lines and movably engaged with stabilizers as described herein. The carriage 201 includes a support body 202 having a first end and a second end. At the first end of the support body 202 is attached a first stabilizer guide 206, and at the second end of the support body 202 is attached a second stabilizer guide 207. Each of the first and second stabilizer guides 206 and 207 can engage a stabilizer to allow for the stabilization of the applicator system 900. Also attached to the support body 202 are a first hoist bracket 204 and a second hoist bracket 205, each of which connects a hoist line to the carriage. The applicator system 900 also includes a first striker 128 and an opposing second striker 129. The first striker 128 is connected to the support body 202 by the first striker mount 126 and the second striker 129 is connected to the support body 202 by the second striker mount 127.

An actuator 211 in the form of a cable cylinder drives the applicator mount assembly 910 along the path with each stroke during operation. The actuator 211 comprises a first pulley 221 and a second pulley 223 rotatably mounted to opposed ends of the actuator 211. A reciprocating cable 209 is operably connected to the first pulley 221 and the second pulley 223 and can move in a reciprocating manner on the first and the second pulleys 221 and 223 when a piston is actuated.

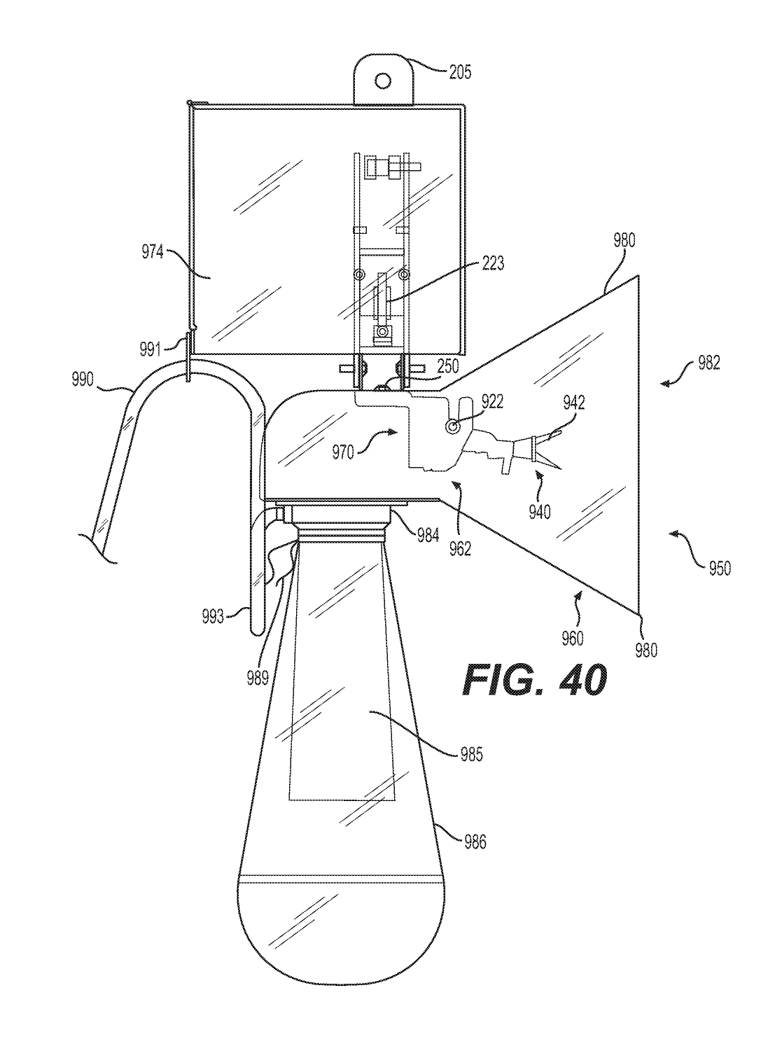

The applicator mount assembly 910 includes a support bracket 214 connected to and supported by roller 212, which movably engages the support body 202 as the applicator mount assembly 910 moves. The applicator mount assembly 910 also includes an applicator mount 970 rotatably mounted to and suspended from the support bracket 214. The is rotatable about an axis extending through both the applicator mount 970 and an applicator mount pivot pin 250, shown in FIG. 40, and includes a spring-activated mechanism, not shown, by which the applicator mount 970 can be biased to a first side and a second side as the applicator mount assembly 910 cycles between the first and second sides of the carriage. The spring-activated mechanism can be similar to that provided in the applicator system 200.

The applicator mount 970 comprises a hanger 946 that can be engaged by the first striker 128 or second striker 129 at the end of an application cycle to adjust the direction of the applicator mount 970 so as to allow for the application of fluidized material to a work surface at a non-perpendicular angle to by the realignment of the fluidized material applicator 940 mounted on the applicator mount 970. The hanger 946 can include one or more slots 917 for receiving one or hanger rods 922 attached to the fluidized material applicator 940 to mount the fluidized material applicator 940 to the applicator mount 970. The fluidized material applicator 940 comprises an internal air-actuated trigger, not shown, that, upon activation, starts the flow of fluidized-material applicator nozzle 942 and stops the flow upon deactivation.

The applicator nozzle 942 of the fluidized material applicator 940 can be aligned perpendicular to a work surface, not shown, as illustrated in FIG. 38 or at angle relative to the work surface, not shown, as illustrated in FIG. 37. A fluidized material can be provided to the fluidized material applicator 940 from a fluidized material receptacle assembly as illustrated in FIG. 20.

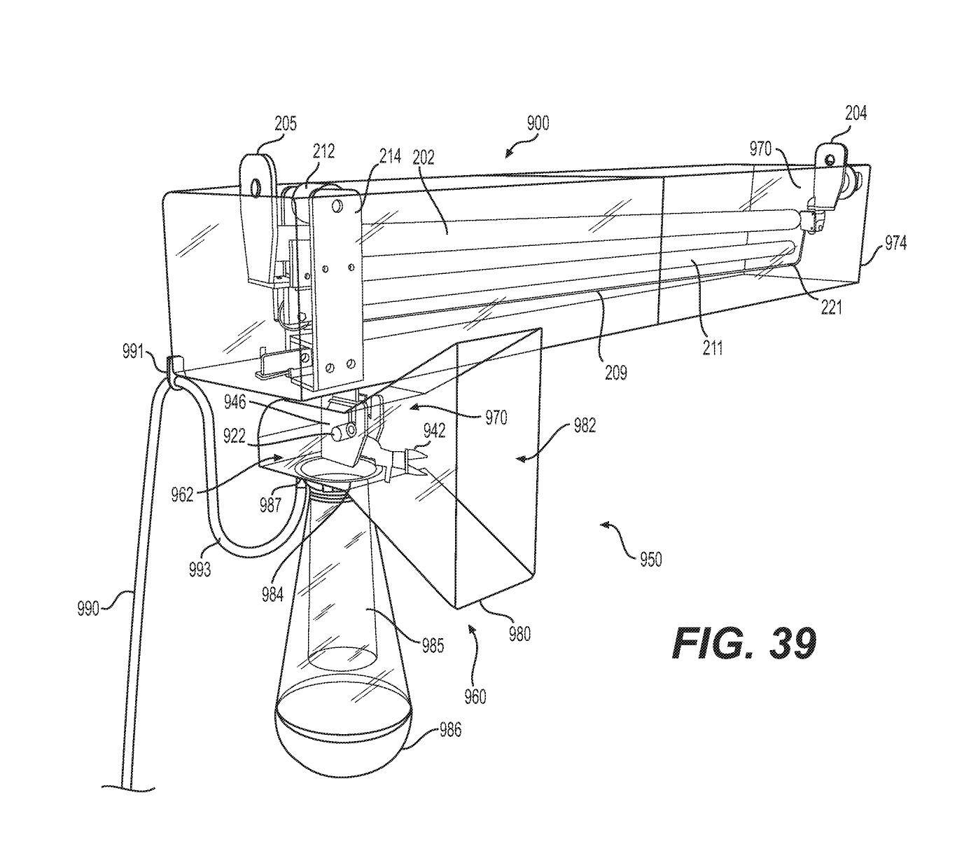

FIGS. 39-41 illustrate a shroud assembly 950 that can be used in conjunction with the applicator systems set forth herein. The shroud assembly 950 comprises a shroud body 960 operably connected to a venturi section 984, an exhaust port 985, an exhaust receptacle 986, and a negative pressure inducer 990. The shroud body 960 defines a shroud chamber 962 in which can be disposed at least a portion of the fluidized material applicator 940. The shroud body 960 also includes a mouth 980 that defines an opening 982 that is in fluid communication with the shroud chamber 962. As shown in FIGS. 39-41, the shroud body 960 can be mounted on the applicator mount 970 and can enclose a portion of both the applicator mount 970 and the fluidized material applicator 940. Since the shroud body 960 is mounted on the applicator mount 970, the shroud body 960 can move in conjunction with the applicator mount 970 both along the rectilinear path defined between the ends of the carriage and pivotally about an axis extending through the pivot pin 250 connecting the applicator mount 970 to the support bracket 214.

The fluidized material applicator 940 is aligned within the shroud chamber 960 with the applicator nozzle 942 pointing outward toward the shroud opening 982 defined by the shroud mouth 980 so that a fluidized material to be applied to a work surface 105 by the fluidized material applicator 940 can proceed from the applicator nozzle 942 and the interior of the shroud chamber 962 through shroud opening 982 to a work surface 105 adjacent to which the shroud opening 982 is aligned.

A venturi section 984 of the shroud assembly 950 is in fluid communication with the shroud chamber 962. A negative pressure inducer 990 can be provided in fluid communication with the venturi section 984 through a pressure port 987 so as to allow negative pressure to be generated at the venturi section 984. The negative pressure inducer 990 is illustrated in FIGS. 39-41 as a hose that is in fluid communication with a source of negative pressure, such as a vacuum pump, compressed air generator, compressed gas cylinder, flowing water or other mechanism by which negative pressure can be generated within at least a portion of the shroud assembly 950. The negative pressure inducer 990 includes an excess line section 993 that is partially secured by a line bracket 991. The excess line section 993 is of sufficient length to allow for the movement, both reciprocating and pivoting, of the negative pressure inducer 990 as the shroud assembly 950 reciprocatingly and pivotally moves with the applicator mount 970.

An exhaust port 985 also can be provided in fluid communication with the venturi section 984 such that the exhaust port 985 is in fluid communication with the shroud chamber 962 via the venturi section 984. The present disclosure encompasses shroud assemblies lacking a venturi section disposed between the exhaust port 985 and the shroud chamber 962, but including a conduit section whereby exhaust from the fluidized material applicator 940 can be drawn through the exhaust port 985. The shroud body 960, the exhaust port 985, the exhaust receptacle 986, and the negative pressure inducer 990 are shown in FIG. 39-41 as having translucent surfaces to show the components of the applicator system 900 that are disposed interior to the various components of the shroud assembly 950. A carriage shroud 974 also is provided with the applicator system 900 and aligned on the outside of the carriage and part of the applicator mount assembly so as to protect the components of the applicator system 900 that are covered thereby. The carriage shroud 974 is illustrated with translucent sidewalls that are disposed adjacent both ends and along both lengthwise sides of the applicator system 900.

The exhaust receptacle 986 is provided in fluid communication with the exhaust port 985 so that the exhaust receptacle 986 is in fluid communication with the venturi section 984 via the exhaust port 985. The exhaust receptacle 986 can be any suitable structure for receiving and containing any excess fluidized material expelled from the exhaust port 985. The exhaust receptacle 986 is illustrated in FIGS. 39-41 as a soft-sided translucent polymeric that is secured to the shroud assembly 950 by a drawstring 989 tied adjacent the neck of the exhaust port 985.

When the applicator system 900 is operated with the shroud assembly 950 mounted thereon, the applicator nozzle 942 of the fluidized material applicator 940 is aligned to spray fluidized material outward through the shroud opening 982 formed by the shroud mouth 980 of the shroud body 960. The shroud opening 982 is aligned adjacent a work surface 105 to allow the fluidized material to be applied thereto. When the fluidized material applicator 940 is in operation, the negative pressure inducer 990 is activated so as to generate negative pressure at the pressure port 987, which opens to the venturi section 987, thereby causing negative pressure within the venturi section 984. The negative pressure generated thereby in the venturi section 984 tends to generate negative pressure in the shroud chamber 962. Excess fluidized material that is expelled into the air adjacent the shroud opening 982 is drawn with the air into the interior of the chamber 962 by the negative pressure environment and onward into the venturi section 984. The excess fluidized material is thereby drawn through the venturi section 984 to the exhaust port 985 and expelled into the exhaust receptacle 986 where the excess fluidized material is collected for disposal. The flow of excess fluidized material through the interior of the shroud chamber 962, the venturi section 984, the exhaust port 985, and into the exhaust receptacle 986 can continue as the applicator system 900 cycles back and forth through the application cycle.

The present disclosure encompasses control systems of remote-controlled application systems and applicator systems that can be programmed to automatically control the movement, alignment, speed, timing, activation and/or deactivation of the systems. Programming of the control systems can be carried out by the setting of the motors, valves, pressure regulators, actuators, and/or pumps by hand; or, if the systems are combined with electrical, electro-mechanical or mechanical control elements, by setting the controls of such elements. The remote-controlled application systems and applicator systems can include wired and/or wireless control units that communicate mechanically, pneumatically, hydraulically and/or electrically with the motors, actuators, drives and other moving components of the systems to allow an operator to control the activation, movement, speed and/or timing of the system components and/or flow rates of the streams of fluidized materials generated thereby. The control units encompassed by the present disclosure can allow an operator to control the operation of the various components of the systems at a distance remote from the systems.

The present disclosure also encompasses methods of applying a fluidized material to a surface. The method can include the steps of robotically applying a fluidized material to a surface using the remote controlled application systems, applicator systems, and/or accessory applicator systems as described herein.

The alignments and configurations of the parts of the applicator system and systems disclosed herein can be varied without departing from the scope of the present disclosure. Other embodiments of the apparatus and system for applying a fluidized material to a surface set forth in the present disclosure will be apparent to those skilled in the art from their consideration of the specification and practice of the present disclosure and are encompassed hereby.

1. A system for use in applying a fluidized material to a surface, wherein the system comprises a carriage, an applicator mount assembly movably mounted to the carriage, wherein the carriage comprises a support body and an actuator mounted to the support body, wherein the applicator mount assembly is operably connected to the actuator, wherein the applicator mount assembly is reciprocatingly movable by the actuator along a path, wherein the applicator mount assembly comprises a support bracket and an applicator mount pivotally mounted to the support bracket, and wherein the applicator mount is configured to receive a fluidized material applicator and move the fluidized material applicator along the path.

2. The system of claim 1, wherein the actuator comprises a cable cylinder comprising a reciprocating cable operably connected to the applicator mount assembly, wherein the applicator mount assembly is reciprocatingly movable along the path by movement of the reciprocating cable.

3. The system of claim 1, further comprising a first striker mounted proximal to a first end of the carriage and a second striker mounted proximal to a second end of the carriage, wherein the first striker and the second striker cooperate with the applicator mount to pivot the fluidized material applicator.

4. The system of claim 1, further comprising a hoist system comprising a hoist motor operably connected to a hoist drum, and a hoist line operably connected to the hoist drum, and wherein the carriage is suspended from the hoist line.

5. The system of claim 4, further comprising a hoist support supporting the hoist system, wherein the hoist support comprises a trolley and a plurality of castors mounted on the trolley.

6. The system of claim 1, wherein the carriage is suspended from a first hoist line and a second hoist line, wherein the first hoist line is connected to the support body proximal to a first end of the support body and the second hoist line is connected to the support body proximal to a second end of the support body.

7. The system of claim 1, wherein the carriage is operably connected to a first stabilizer and a second stabilizer, wherein the first stabilizer is operably connected to the support body proximal to a first end of the support body and the second stabilizer is operably connected to the support body proximal to a second end of the support body.

8. The system of claim 1, further comprising a shroud assembly supported by the applicator mount assembly, wherein the shroud assembly comprises a shroud body defining a shroud chamber and a shroud opening, wherein the shroud opening is in fluid communication with the shroud chamber, a venturi section in fluid communication with the shroud chamber, an exhaust port in fluid communication with the venturi section, an exhaust receptacle in fluid communication with the exhaust port, and wherein at least a portion of the fluidized material applicator is disposed within the shroud chamber.

9. The system of claim 1, wherein the fluidized material applicator comprises a trigger, and wherein the applicator mount comprises a trigger actuator operably connected to the trigger.

10. The system of claim 1, further comprising a control system operably connected to the actuator.

11. The system of claim 10, wherein the control system comprises a pneumatic control assembly configured to receive a compressed gas.

12. The system of claim 1, wherein the carriage is suspended from a telescoping support arm.

13. The system of claim 1, further comprising a traction hoist connected to the carriage.

14. The system of claim 1, wherein the applicator mount assembly further comprises an accessory support arm pivotally mounted to the support bracket, an accessory applicator actuator mounted on the accessory support arm, an accessory applicator arm mounted on the accessory support arm, wherein the applicator mount is connected to the accessory applicator arm, wherein the fluidized material applicator is operably connected to the accessory applicator actuator, and wherein the fluidized material applicator is reciprocatingly movable by the accessory applicator actuator along a second path.

15. The system of claim 14, wherein the fluidized material applicator is a roller.

16. A system for applying a fluidized material to a surface, the system comprising:
a carriage comprising a support body and a cable cylinder mounted to the support body, wherein the cable cylinder comprises a reciprocating cable;
an applicator mount assembly mounted on the support body and operably connected to the reciprocating cable, wherein the applicator mount assembly comprises a support bracket and an applicator mount mounted to the support bracket, wherein the applicator mount is configured to receive a fluidized material applicator, wherein the applicator mount assembly is reciprocatingly movable along a path by cooperation of the applicator mount assembly with the reciprocating cable; and,
a first striker mounted to the carriage and a second striker mounted to the carriage, wherein the first striker and the second striker are aligned to cooperate with the applicator mount assembly to pivot the fluidized material applicator.

17. The system of claim 16, further comprising a hoist line operably connected to the carriage, wherein the carriage is movable by cooperation with the hoist line.

18. The system of claim 17, further comprising a hoist system comprising a hoist motor operably connected to a hoist drum, wherein the hoist line is operably connected to the hoist drum, and wherein the carriage is suspended from the hoist line.

19. The system of claim 18, further comprising a hoist support supporting the hoist system, wherein the hoist support comprises a trolley and a plurality of castors mounted on the trolley.

20. The system of claim 19, further comprising a stabilizer mounted to the trolley, wherein the stabilizer is operably connected to the carriage to stabilize the carriage.

21. The system of claim 16, wherein the fluidized material applicator comprises a trigger, and wherein the applicator mount comprises a trigger actuator operably connected to the trigger.

22. The system of claim 16, further comprising a shroud assembly supported by the applicator mount assembly, wherein the shroud assembly comprises a shroud body defining a shroud chamber and a shroud opening, wherein the shroud opening is in fluid communication with the shroud chamber, a venturi section in fluid communication with the shroud chamber, an exhaust port in fluid communication with the venturi section, an exhaust receptacle in fluid communication with the exhaust port, and wherein at least a portion of the fluidized material applicator is disposed within the shroud chamber.

23. The system of claim 16, further comprising a control system operably connected to the cable cylinder.

24. The system of claim 23, wherein the control system comprises a pneumatic control assembly configured to receive a compressed gas.

25. The system of claim 16, wherein the carriage is suspended from a telescoping support arm.

26. The system of claim 16, further comprising a traction hoist connected to the carriage.

27. The system of claim 16, wherein the applicator mount assembly further comprises an accessory support arm pivotally mounted to the support bracket, an accessory cable cylinder mounted on the accessory support arm, wherein the accessory cable cylinder comprises an accessory reciprocating cable, an accessory applicator arm mounted on the accessory support arm, wherein the applicator mount is attached to the accessory applicator arm, wherein the fluidized material applicator is operably connected to the accessory reciprocating cable, and wherein the accessory applicator is reciprocatingly movable by the accessory reciprocating cable along a second path.

28. The system of claim 17, wherein the fluidized material applicator is a roller.
